(19) United States
(12) Patent Application Publication
(10) Pub. No.: US 2025/0083112 A1
(43) Pub. Date: Mar. 13, 2025

(54) HIGH LOAD NANOPARTICLE MICROPOROUS FILTER FOR CATION REMOVAL AND/OR RECOVERY

(71) Applicants: B. G. NEGEV TECHNOLOGIES AND APPLICATIONS LTD., Beer-Sheva (IL); TECHNION RESEARCH & DEVELOPMENT FOUNDATION LIMITED, Haifa (IL)

(72) Inventors: Oded NIR, Midreshet Ben Gurion (IL); Mohit CHAUDHARY, Midreshet Ben Gurion (IL); Ori LAHAV, Haifa (IL); Paz NATIV, Haifa (IL)

(21) Appl. No.: 18/958,085

(22) Filed: Nov. 25, 2024

Related U.S. Application Data
(63) Continuation of application No. PCT/IL2023/050540, filed on May 24, 2023.
(60) Provisional application No. 63/345,447, filed on May 25, 2022.

(51) Int. Cl. B01D 69/14; B01D 65/02; B01D 71/02; C02F 1/42; C02F 101/10

(52) U.S. Cl. CPC B01D 69/14111; B01D 65/02; B01D 71/02; C02F 1/42; B01D 2325/02831; B01D 2325/02832; B01D 2325/02833; B01D 2325/02834; C02F 2001/422; C02F 2101/10

(57) ABSTRACT

This invention relates to a device comprising polyethylene sulfone (PES) and additional suitable polymers with high load of Prussian blue analogue nanoparticles for removal of monovalent or divalent cation contaminants, optionally doped, and process for the preparation and methods for use thereof. The device and method relate to selectively and effectively remove ammoniacal nitrogen removal and recovery as a valuable resource, and removing radioactive cesium and/or other monovalent or divalent cations from contaminated water.

### CROSS REFERENCE TO RELATED APPLICATIONS

This application is a Bypass Continuation of PCT Patent Application No. PCT/IL2023/050540 having International filing date of May 24, 2023, which claims the benefit of priority of U.S. Provisional Patent Application No. 63/345,447, filed May 25, 2022, the contents of which are all incorporated herein by reference in their entirety.

### FIELD OF THE INVENTION

This invention relates to a method and system for cation removal and recovery using a microporous filter.

This invention relates to a device comprising polyethylene sulfone (PES) and additional suitable polymers with high load of Prussian blue analogue nanoparticles for removal of monovalent or divalent cation contaminants, optionally doped, and process for the preparation and methods for use thereof. The device and method relate to selectively and effectively remove ammoniacal nitrogen removal and recovery as a valuable resource, and removing radioactive cesium and other monovalent or divalent cations from contaminated water.

### BACKGROUND OF THE INVENTION

Ammoniacal nitrogen (NH3-N) removal is critical in various applications, including domestic wastewater treatment, industrial wastewater treatment, aquaculture water management, and growth media recycling in cultured meat production. Ammoniacal nitrogen, which includes ammonia (NH₃) and ammonium (NH₄⁺), is a common pollutant in wastewater and water sources. Its removal is necessary to prevent environmental contamination, ensure water quality, and comply with regulatory standards. Additionally, in the context of aquaculture and cultured meat production, ammoniacal nitrogen removal is crucial for maintaining optimal conditions for aquatic organisms and cultured meat cells to thrive. Besides its removal, the need to recover and recycle NH3-N as fertilizer or reagent is increasingly recognized.

### Aquaculture Ammoniacal Nitrogen Removal

Aquaculture plays the leading role in meeting seafood and fish demand and remains one of the fastest-growing food-producing sectors. Aquaculture production provides more than half of all fish for human consumption. This share is forecast to rise to 62% by 2030 as catches from wild capture fisheries level off. With population growth, aquaculture will continue to expand, so technologies with higher efficiency should be adopted to increase production. On the other hand, due to concerns regarding the detrimental impacts of aquaculture production on the environment and increased regulations on aquaculture effluents, the aquaculture industry is focused on developing new methods to minimize the toxic contaminants in aquaculture waters in recycling systems and wastewater of aquaculture ponds.

Harmful effects attributed to aquaculture practices are of foremost concern to the industry and are subject to increasing public awareness. Often, these harmful effects are related to the environmental impact of aquaculture activities, among those: the destruction of natural sites such as wetlands and mangroves, the spread of diseases, decreased biodiversity of wild fish populations by the escape of nonnative fish species, and pollution. Wastewater discharged from aquaculture contains nitrogenous compounds (ammonia, nitrite, and nitrate), phosphorus, and dissolved organic carbon, which causes environmental deterioration at high concentrations.

NH3-N is the primary nitrogenous waste of aquatic animals, particularly in modern intensive fish farms or closed-system fish cultures with high densities. NH3-N is produced by the de-amination of protein in aquaculture feeds and is excreted primarily through fish's gills, while decaying unused feed is an additional source. The fish excretion is proportional to the feeding rate and the protein level in the feed. Ammonia is toxic to fish if it accumulates in the fish's body. When the ammonia concentration reaches a toxic level (above 0.02 ppm), it can have sublethal effects on fish, such as slower growth rate, poor feed conversion, reduced resistance to different diseases, and eventually death.

Development of ammonia removal and recovery technology in aquaculture has significant market potential due to the increasing demand for sustainable and efficient practices. This technology can help reduce the environmental impact of aquaculture by minimizing the discharge of ammonia into surrounding waters and, at the same time, recovering valuable nutrients for use as fertilizer or animal feed. The market potential is supported by the growth of the global aquaculture industry projected to reach $245.9 billion by 2026.

In addition, increasing concerns about the environmental impact of aquaculture and the need for sustainable practices drive the demand for innovative technologies that can reduce the industry's ecological footprint.

Therefore, there is a need to adopt ammonia removal and recovery technology not only to improve the overall health of aquaculture systems but also provide significant economic benefits to farmers by reducing the cost of waste management and creating a new source of revenue through the sale of recovered nutrients, and significantly reducing water consumption in recirculated aquaculture systems (RAS) by decreasing the water exchange rate that is now high (20-40% typically) due to dissolved nitrogen accumulation.

Several technologies have been developed for ammonia removal and recovery in aquaculture, including biological, physical, and chemical processes such as coagulation, filtration, chlorination, UV, and ozone treatments. However, these technologies are not considered advanced enough for total ammonia nitrogen (TAN) and nitrate ion removal and have limitations restricting their widespread adoption in the industry.

Several techniques are available to remove total ammonia nitrogen and nitrate, which can be divided into two main categories: physicochemical and biological. Physicochemical treatment methods include ion exchange (IE), reverse osmosis (RO), electrodialysis (ED), and activated carbon adsorption. Biological systems, such as bacteria, carry out biological treatments that convert total ammonia nitrogen to nitrate and nitrate to nitrogen gas. No byproducts are formed, and further treatment is not required for this method. However, these processes can be slow and depend on environmental conditions, such as temperature, pH, and dissolved oxygen levels. Furthermore, physical processes, such as filtration and sedimentation, may not effectively remove all ammonia forms, mainly dissolved ones. Chemical processes such as adsorption and precipitation effectively remove ammonia but can be expensive and generate waste products that need proper disposal.

Additional technologies are advanced oxidation processes (AOPs) and membrane-based systems. AOPs utilize potent oxidants such as ozone or hydrogen peroxide to break down ammonia into less toxic compounds. They can be effective in removing both dissolved and particulate forms of ammonia. Membrane-based systems utilize selective membranes that selectively remove ammonium and other pollutants from water. These technologies have shown promise in laboratory and pilot-scale studies, but further research and development are needed to improve their performance and cost-effectiveness in real-world aquaculture systems. Therefore, there is a need for aquaculture's ammoniacal nitrogen removal and recovery technology that can meet the increasing demand for sustainable and efficient aquaculture practices.

Another aquaculture technology for ammoniacal nitrogen removal and recovery is ion exchange using zeolites. Zeolites are microporous natural or synthetic hydrated aluminosilicate minerals, which have various applications because of their unique physicochemical characteristics, such as ion exchange and sorption properties. The zeolite structure forms a network of channels and cavities that allow easy penetration of micronized molecules and filtering them according to size, polarity, and shape, leading to adsorption and filtration of various substances that come into contact with zeolites. The unique structure of zeolites with high porosity allows efficient adsorption (charging) and rapid desorption (regeneration) of a wide range of charged elements. Zeolites were mainly used to reduce or eliminate the content of ammonium and minimize odors emitted from fish excretion. Many factors affect zeolite efficiency, such as conductivity, pH, temperature, initial concentration of cations of the treated water, the zeolite particle size, and contact time. Significant progress has been made in recent years on applications of these inorganic adsorbents in different industries, including agriculture, aquaculture, water and wastewater treatment, air purification, and petrochemicals. The main interest in zeolites in aquaculture relates to the control of total ammonia nitrogen (TAN) concentration. Ammonia is toxic to fish, shrimp, and other aquatic animals. Zeolite is used to lessen TAN concentrations in aquaria, fish holding tanks, water-recirculating aquaculture systems, and water containers for transporting aquatic animals. This use is widely documented, especially in freshwater aquaculture, while the level of success in brackish and marine aquaculture was significantly reduced. Ion exchange using zeolite effectively removes ammonium from freshwater aquaculture systems. It can also recover ammonium ions as concentrated solutions, and by further processing, as solid products for fertilizer or animal feed. However, ion exchange with zeolite in high-salinity water can be limited due to the potential for fouling or clogging of the zeolite pores, which can reduce its effectiveness and lifespan.

Several studies have addressed this limitation by using modified zeolites or other materials with high ion exchange capacity and better resistance to fouling in high-salinity water. For example, some researchers have explored using chitosan-coated zeolite, showing improved stability and higher ammonium removal capacity in seawater. Others have investigated ion exchange resins, which can remove ammonium and other ions from high-salinity water while maintaining their performance over extended periods.

In addition to fouling and clogging of zeolite pores in high-salinity water, another limitation of zeolite ion exchange is limited selectivity towards ammonium ions in high-salinity water. When treating complex water matrices (e.g., seawater), other cations, such as sodium, potassium, calcium, and magnesium, compete with ammonium for the exchange sites. For example, the use of natural zeolite in intensive shrimp pond culture is widespread, mainly in South-East Asian countries. However, there are some doubts regarding the efficacy and cost-effectiveness of zeolites in improving water quality due to high levels of competing cations. This selectivity issue is more pronounced in high-salinity water, where the concentration of other cations is typically higher than in freshwater. To address this limitation, researchers have explored alternative ion exchange materials, such as modified zeolites, hybrid materials, and other synthetic resins with higher selectivity towards ammonium ions, e.g., composite materials incorporating zeolite particles into polymer matrices, synthetic resins with a specific functional group that can selectively remove ammonium ions over other cations in seawater, etc.

Ammonium removal efficiency of zeolites is 40% higher in freshwater compared with marine water. Although the removal efficiency of ammonium in saltwater by zeolites is lower than in freshwater, it still has the highest efficiency and lowest cost compared to other materials in the same class, such as activated carbon. However, ion exchange using zeolites still faces challenges in treating high-salinity water in aquaculture systems, and further research is needed to optimize its performance and cost-effectiveness.

The ongoing research and development of highly selective and efficient ion exchange materials for ammonia removal and recovery in high-salinity water suggest a significant need for a solution that can overcome the limitations of existing technologies and provide a more sustainable and efficient way to manage ammonia in aquaculture systems, and nutrient recovery from wastewater streams.

### Industrial Wastewater

NH3-N is a common pollutant in industrial wastewater, and its removal is crucial in various sectors. For instance, the pharmaceutical industry generates wastewater containing NH3-N from drug synthesis, purification, and cleaning processes. Similarly, the microprocessor manufacturing industry produces wastewater with high NH3-N concentrations due to the use of ammonia-based cleaning agents in semiconductor fabrication processes. Among other sectors that generate NH3-N-laden wastewater are the food and beverage industry, petrochemicals, textile, fertilizer industry, and mining.

Industries implement different technologies for ammonia removal from wastewater. For instance, biological treatment methods such as activated sludge systems or membrane bioreactors can convert NH3-N to nitrate and nitrogen gas. Alternatively, chemical methods such as stripping, where ammonia is volatilized using air or steam, or ion exchange, where ammonium ions are exchanged with other ions in a resin, can also be employed for NH3-N removal. Reverse osmosis and electrodialysis are membrane-based processes that effectively remove ammonia from wastewater. Furthermore, emerging technologies are being explored for NH3-N removal from industrial wastewater. For example, electrochemical methods, such as electrocoagulation and electro-oxidation, which involve the use of electric currents to remove ammonia by forming solid particles or oxidizing it to nitrogen gas, are gaining attention. Additionally, advanced oxidation processes, such as UV/H₂O₂ and ozone treatment, can be used to oxidize and remove NH3-N from wastewater. These technologies offer the potential for higher removal efficiencies and reduced sludge production compared to conventional methods.

### Domestic Wastewater

Domestic wastewater contains high levels of NH3-N. The standard method of removing NH3-N at large centralized wastewater treatment plants (WWTPs) is through biological processes, i.e., nitrification and denitrification. In these processes, bacteria convert the nitrogen in the wastewater into N2 gas, which is then released into the atmosphere. This process can be energy-intensive and requires careful management of the aeration and mixing systems, but it can effectively reduce nitrogen levels in the effluent.

Smaller distributed wastewater treatment facilities often face challenges in removing nitrogen from domestic wastewater. These facilities may not have access to the same technology or resources as larger centralized WWTPs and may struggle to meet regulatory requirements for nitrogen removal. Some of the main challenges faced by smaller facilities include limited space for treatment systems, high costs of advanced treatment technologies, and difficulties in maintaining consistent treatment performance. In order to address these challenges, smaller facilities may need to explore alternative treatment options, such as constructed wetlands or nutrient removal reactors and work closely with regulatory agencies to develop effective management strategies.

Therefore, there is a need for NH3-N polishing in domestic wastewater.

### Growth Media Recycling

In the emerging industry of cultured meat and alternative protein production, recycling growth media is essential to improve sustainability and reduce production costs. Growth media are typically nutrient-rich solutions used to support the growth of cells in cell culture, which are vital to the production of cultured meat. However, these growth media can become contaminated over time, accumulating ammonium, a toxic by-product of cellular metabolism that can inhibit cell growth and reduce the quality of the final product. Recycling the growth media is considered a primary bottleneck for scaling up cultured meat production and achieving sustainability by reducing the reliance on traditional animal agriculture for meat production.

To maintain the quality and safety of the growth media, it is necessary to remove ammonium from the solution. Currently, there are no effective means of ammonium removal from spent growth media. Biological methods cannot be applied because of sterilization needs. Additionally, harsh physicochemical methods like alkaline ammonia stripping or thermal-based methods cannot be used due to the sensitivity of some growth promoters. Applying zeolite-based ion exchange resins can remove ammonium to some extent. However, the efficiency will be low due to the relatively high salt concentration and presence of other cations in the growth media.

Therefore, there is a need for a system and/or method to remove ammonium from growth media effectively.

### Cesium Removal

Removing radioactive cesium from water is critical due to the severe health risks associated with its contamination. Radioactive cesium is a dangerous and long-lasting radioactive isotope that can be released into water bodies e.g., as a result of nuclear accidents, such as Fukushima, or from nuclear waste disposal sites. Once cesium enters the water supply, it can accumulate in aquatic organisms and eventually enter the human food chain, posing severe health hazards, including an increased risk of cancer and other radiation-related illnesses. Furthermore, cesium contamination can persist for decades, causing long-term environmental damage.

Removing radioactive cesium from water presents several challenges that need to be addressed. First and foremost, cesium is a highly soluble element, making it difficult to separate and remove from water using conventional water treatment methods. Additionally, radioactive cesium often exists in complex chemical forms and can be present in varying concentrations, which adds to the complexity of its removal. The high costs associated with developing and implementing effective cesium removal technologies also pose a challenge, especially for areas affected by nuclear accidents or with limited financial resources.

Therefore, it is imperative to develop effective methods and technologies to remove radioactive cesium from water to protect human health, safeguard the environment, and ensure the safety of our water resources for future generations.

### SUMMARY OF THE INVENTION

This invention relates to a method and system for cation removal and recovery using a microporous filter.

This invention relates to a device comprising polyethylene sulfone (PES) and additional suitable polymers with high load of Prussian blue analogue nanoparticles for removal of monovalent or divalent cation contaminants, optionally, doped with e.g., by ferric ions, and process for the preparation and methods for use thereof. The device and method relate to selectively and effectively remove ammoniacal nitrogen removal and recovery as a valuable resource, and removing radioactive cesium and/or other monovalent and divalent cations from contaminated water.

Some embodiments relate to a microfilter for the selective removal of cations from water, the microfilter comprising an active layer deposited on a porous support, wherein the active layer comprises a) a polymer matrix, and b) a high load of ion exchange nanoparticle material embedded within the polymer matrix, wherein the active layer may be doped with a doping agent to reduce or prevent leaching of the nanoparticles.

According to some embodiments, the polymer matrix may include a plurality of voids, wherein the plurality of voids may be macro voids with a diameter of between about 5,000 nm to about 100,000 nm, and/or micro voids with a diameter of between about 5 nm to about 5,000 nm. Optionally, the nanoparticles are located in and/or attached to the walls of the micro and/or macro voids of the polymer matrix.

According to some embodiments, the porous support may be a non-woven fabric, wherein the non-woven fabric may be a non-woven material selected from wool felt, cotton, jute, kenaf, flax polyethylene (PE), nylon polypropylene (PP), polyester (PET), nylon (PA), viscose fiber, acrylic fiber, polyethene fiber (HDPE), chlorine fiber (PVC), and any combination thereof. According to some embodiments, the porous support may include pores with a diameter of between about 0.01 nm to about 1,000,000 nm.

According to some embodiments, the polymer matrix may be selected from the group consisting of polyethersulfone (PES), Polyvinylidene Fluoride (PVDF), Polyacrylonitrile (PAN), Polysulfone (PS), sulfonated polysulfone (sPS), acetate, triacetate, and any combination thereof.

According to some embodiments, the polymer matrix may be loaded with between about 30 wt/wt % to about 80 wt/wt % of ion exchange nanoparticles. According to some embodiments, the ion exchange nanoparticles may have a diameter of between about 10 nm to about 50,000 nm.

According to some embodiments, the ion exchange nanoparticles may be an ion exchange resin, a Prussian-blue analogue, zeolite, and any combination thereof. For example, the Prussian-blue analogue may be a metal hexacyanoferrate (MHCF), such as zinc hexacyanoferrate (Zn-HCF), copper hexacyanoferrate (Cu-HCF), cobalt hexacyanoferrate (Co-HCF), indium hexacyanoferrate (In-HCF), platinum hexacyanoferrate (Pt-HCF), potassium hexacyanoferrate (K-HCF), Aluminum hexacyanoferrate (Al-HCF), and any combination thereof.

According to some embodiments, a doping solution may include the doping agent in an amount of between about 0.0001 wt % to about 1 wt % of the total dope solution. According to some embodiments, the doping agent may be one or more ions, one or more water-soluble inorganic compound, one or more acids, one or more bases, and any combination thereof. According to some embodiments, the one or more ions may be selected from the group consisting of ferric ions, manganese ions, aluminum ions, copper ions, zinc ions, nickel ions, cobalt ions, and any combination thereof.

According to some embodiments, the doping agent may be selected from the group consisting of ferric chloride, ferric nitrate, ferric sulfate, sodium aluminate, potassium aluminum sulfate, aluminium chloride, aluminium sulfate, hydrochloric acid, sulfuric acid, phosphoric acid, nitric acid, acetic acid, boric acid, hydrofluoric acid, oxalic acid, citric acid, carbonic acid, lithium hydroxide, sodium hydroxide, barium hydroxide, strontium hydroxide, potassium hydroxide, calcium hydroxide, dimethylketone, methylamine, pyridine, and any combination thereof.

According to some embodiments, the active layer may have a thickness of between about 100 μm to about 1,000 μm. According to some embodiments, the active layer may be deposited onto the porous support using an automatic film applicator or roll-to-roll production.

According to some embodiments, the cation may be a monovalent or divalent cation, such as ammonium, cesium ions, lead ions, cadmium ions and any combination thereof.

According to some embodiments, the microfilter may be used in removal of one or more cations from domestic and industrial wastewater treatment, aquaculture water management, cultured meat production or toxic spills.

According to some embodiments, the microfilter may be used in the recovery of one or more cations from domestic and industrial wastewater treatment, aquaculture water management, cultured meat production or toxic spills.

According to some embodiments, the microfilter may be regenerated after use.

Some embodiments relate to a method for removing cations from water, the method including:
contacting a microfilter with contaminated water, wherein the microfilter comprise:
   an active layer deposited on a porous support, wherein the active layer comprises:
      a polymer matrix; and
      a high load of ion exchange nanoparticle material embedded within the polymer matrix;
wherein the active layer is doped with a doping agent for reducing or preventing leaching of the nanoparticles.

According to some embodiments, the exposing may be by dead-end filtration.

According to some embodiments, the method may include regenerating the microfilter by exposing the microfilter to a regeneration medium. According to some embodiments, the regeneration medium may be a concentrated aqueous solution comprising an acid or salt selected from the group consisting of NaCl, KCl, MgCl₂, Na₂SO₄, CaCl₂, H₂SO₄, HCl, and any combination thereof.

According to some embodiments, the method may include recovering the removed cations by exposing the microfilter to a regeneration medium. According to some embodiments, the regeneration medium may be a concentrated aqueous solution comprising an acid or salt selected from the group consisting of NaCl, KCl, MgCl₂, Na₂SO₄, CaCl₂, H₂SO₄, HCl, and any combination thereof.

Some embodiments relate to a method for the preparation of a microfilter for the selective removal of cations from water, the method comprising:
combining a polymer with an ion exchange nanoparticle suspension in a polar aportic solvent;
doping the solution with a doping agent;
depositing the solution onto a porous support to produce an active layer film comprising of a matrix formed by the polymer, wherein the polymer matrix comprises the ion exchange nanoparticles.

According to some embodiments, the method may further include degassing the solution. According to some embodiments, the method may further include phase inversion of the active layer film. According to some embodiments, the phase inversion may take place in a deionized water bath at 19±1° C.

According to some embodiments, the polar aprotic solvent may be selected from the group consisting of N-methyl-2-pyrrolidone, dimethyl sulfoxide, dimethylformamide, dioxane, hexamethylphosphorotriamide, acetone, tetrahydrofuran, chloroform, ethyl acetate, and any combination thereof.

According to some embodiments, the polymer matrix may be loaded with between about 20 wt/wt % to about 80 wt/wt % of ion exchange material.

According to some embodiments, the doping solution may include the doping agent in an amount of between about 0.0001 wt % to about 1 wt % of the total dope solution. According to some embodiments, the doping agent may be selected from the group consisting of ferric ions, manganese ions, aluminum ions, copper ions, zinc ions, nickel ions, cobalt ions, ferric chloride, ferric nitrate, ferric sulfate, sodium aluminate, potassium aluminum sulfate, aluminium chloride, aluminium sulfate, hydrochloric acid, sulfuric acid, phosphoric acid, nitric acid, acetic acid, boric acid, hydrofluoric acid, oxalic acid, citric acid, carbonic acid, lithium hydroxide, sodium hydroxide, barium hydroxide, strontium hydroxide, potassium hydroxide, calcium hydroxide, dimethylketone, methylamine, pyridine, and any combination thereof.

According to some embodiments, the porous support may be a non-woven fabric selected from the group consisting of wool felt, cotton, jute, kenaf, flax polyethylene (PE), nylon polypropylene (PP), polyester (PET), nylon (PA), viscose fiber, acrylic fiber, polyethene fiber (HDPE), chlorine fiber (PVC), and any combination thereof.

According to some embodiments, the depositing the active layer onto the porous support may be by casting or spun like hollow fibers. According to some embodiments, the casting may be by an automatic film applicator or roll-to-roll production. According to some embodiments, the active layer may have a thickness of between about 100 μm to about 1,000 μm. According to some embodiments, the ratio of the thickness of the porous support layer to the thickness of the active layer may range between about 1:1 to about 1:5.

According to some embodiments, the microfilter may be prepared ex-situ.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some, or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Examples illustrative of embodiments are described below with reference to figures attached hereto. In the figures, identical structures, elements, or parts that appear in more than one figure are generally labeled with the same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1: A process diagram for selectively removing and/or recovering ammonium ions from contaminated water by a cation removal and recovery microporous filter, in accordance with some embodiments.

FIG. 2: A process diagram for selectively removing cesium ions from contaminated water by a cation removal and recovery microporous filter, in accordance with some embodiments.

FIG. 3: A process diagram for selectively removing and/or recovering ammonium and cesium ions from contaminated water by a cation removal and recovery microporous filter, in accordance with some embodiments.

FIG. 4: A cross-sectional schematic diagram of a microporous filter, in accordance with some embodiments.

FIGS. 5A and 5B: Exemplary photographs of Microfilter38.5 and Microfilter50, respectively, in accordance with some embodiments.

FIG. 6: Surface (a) and cross-sectional SEM images (b, c, d) of Microfilter38.5, in accordance with some embodiments.

FIG. 7: Surface (a) and cross-sectional SEM images (b, c, d) of Microfilter50, in accordance with some embodiments.

FIGS. 8A and 8B: Exemplary photographs of Cu-HCF50 and Co-HCF50 microporous filters, respectively, in accordance with some embodiments.

FIG. 9: A schematic diagram of an exemplary dead-end filtration set up, in accordance with some embodiments.

FIG. 10: A schematic diagram of an exemplary Zeolite-Na column experimental setup.

FIG. 11A-D: Comparison of ammonium removal by Microfilter38.5 and Microfilter50.

FIG. 12A-D: Charts showing ammonium removal (%) performance (A), accumulative ammonium concentration in treated water (B), breakthrough curve (C) and recovery of ammonium (D).

FIG. 13: Chart showing ammonium removal, breakthrough curve, and accumulative ammonium concentration during spiked Brackish water (NH4-N: 30 mg/L, pH: 7.8, conductivity: about 4 mS) experiment. Permeate flux during the experiment was about 43 LMH.

FIG. 14: Chart showing accumulative permeate ammonium concentration during microfilter recovery. The regeneration media was 4 M NaCl.

FIG. 15: Chart showing ammonium removal performance repeat experiment with another microfilter50 (permeate flux: 40 LMH).

FIGS. 16A and 16B: Ammonium removal from seawater and accumulative ammonium concentration, respectively (42 LMH, 41.2 LMH for 20 and 10° C.).

FIGS. 17A and 17B: Ammonium removal from fish aquaculture pond water and accumulative ammonium concentration, respectively.

FIGS. 18A and 18B: Thomas model fitting for Microfilter50 (A) and Zeolite-Na (B).

FIGS. 19A and 19B: Thomas model fitting to predict ammonium removal capacity of Microfilter50 (A) and Zeolite-Na (B) for 0.15 M NaCl in presence of other mono and divalent ions.

FIG. 20: Effect of NaOH on microfilter performance.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Some embodiments relate to a system and method selectively removing and/or recovering monovalent or divalent cations (e.g., ammonium ions, potassium ions, cesium ions, rubidium ions, lead ions, cadmium ions, etc.) from contaminated water by a cation removal and/or recovery microporous filter. Optionally, the contaminated water may include domestic wastewater treatment, industrial wastewater treatment, aquaculture water management, growth media recycling in cultured meat production, and/or toxic spills (e.g., nuclear accidents, industrial accidents, waste overflow, etc.).

As used herein, according to some embodiments, the term “selective” may relate to targeting particular components in a mixture or matrix.

As used herein, according to some embodiments, the term “monovalent cation” may relate to a positively charged ion with an oxidation state of +1. As used herein, according to some embodiments, the term “divalent cation” may relate to a positively charged ion with an oxidation state of +2.

As used herein, according to some embodiments, the terms “ammonium” and “ammonia ion” may be used interchangeably to relate to an ion NH₄⁺ produced by the combination of ammonia with a hydrogen ion.

As used herein, the term “cesium ion” relates to the +1 oxidation state of cesium ion, a monovalent inorganic cation.

As used herein, according to some embodiments, the term “microporous filter” and “microfilter” may be used interchangeably and relate to filters used in a physical and/or chemical and/or electrochemical filtration process where a contaminated fluid is passed through a microporous membrane (filter) to separate selected ions from the fluid

As used herein, the term “microporous”, according to some embodiments, may relate to a material characterized by very small pores or channels with diameters in the micron or nanometer range.

As used herein, according to some embodiments, the term “high load” may relate to a load of about 30% wt/wt or higher. According to some embodiments, the term “high load” may relate to a load of between about 30% wt/wt to about 90% wt/wt, between about 35% wt/wt to about 80% wt/wt, between about 40% wt/wt to about 70% wt/wt, between about 45% wt/wt to about 60% wt/wt, or between about 35% wt/wt to about 65% wt/wt. Each possibility is a separate embodiment.

According to some embodiments, the system may include an ion selective microfilter. According to some embodiments, the microfilter may include ion exchange nanoparticle material embedded in a polymer matrix. According to some embodiments, the polymer matric may include a high load of ion exchange nanoparticle material.

Advantageously, the microfilter may have significant advantages over existing technologies for ammonium removal. Unlike zeolite-based filters, the microfilter with embedded ion exchange material may be highly effective even in the presence of a mixture of ions and/or high salt concentrations, such as seawater, brackish water, etc. Advantageously, the microfilter may be a superior option for applications where the water source may contain a complex mixture of contaminants, and where zeolite-based filters may be less efficient. According to some embodiments, advantageously, the microfilter may rapidly and selectively remove and/or recover one or more selected ions, e.g., ammonium ions, cesium ions, etc., from mixed ionic solutions.

According to some embodiments, the microfilter may include an active layer of a polymer matrix embedded with a high load of ion exchange nanoparticle material on a porous support, e.g., fabric, membrane, etc. According to some embodiments, the microfilter may be produced by casting, spun like hollow fibers, e.g., by wet spinning, melt spinning, dry spinning, etc.

According to some embodiments, the microfilter may be prepared as a mixed matrix membrane via an ex-situ method. According to some embodiments, the ion exchange nanoparticle material may be prepared, modified, and/or activated prior to addition to the polymer matrix. According to some embodiments, the term “mixed matrix membrane” may relate to a membrane comprising one or more components, e.g., nanoparticles embedded within a polymer matrix. According to some embodiments, the term “ex-situ method” may relate to preparing, modifying, and/or activating one or more components of the mixed matrix membrane prior to combining. According to some embodiments, the term “in-situ method” may relate to preparing, modifying, and/or activating one or more components of the mixed matrix membrane once they have been combined.

According to some embodiments, the microfilter may advantageously include high ion exchange nanoparticle loading to facilitate high dynamic adsorption capacity and rapid kinetics of monovalent or divalent cation absorption e.g., far superior to any prior art membranes by orders of magnitude.

According to some embodiments, the ion exchange nanoparticles may be an ion exchange resin, zeolite, or Prussian-blue analogue, such as metal-hexacyanoferrate (MHCF), etc. and/and any combination thereof. Each possibility is a separate embodiment. Advantageously, the ion exchange nanoparticle material may be selective towards one or more ions, e.g., monovalent or divalent cations. For example, metal hexacyanoferrate embedded in polyethersulfone has high selectivity towards several monovalent cations, such as ammonium, potassium, rubidium, cesium, etc.

As used herein, according to some embodiments, the term “nanoparticle” may relate to a particle of matter that is between 1 and 500 nm in diameter. According to some embodiments, the microfilter may include nanoparticles of one or more ion exchange materials.

According to some embodiments, the diameter of ion exchange nanoparticles may be between about 1 nm to about 10 nm, between about 10 nm to about 50 nm, between about 50 nm to about 100 nm, between about 100 nm to about 200 nm, between about 200 nm to about 500 nm, between about 500 nm to about 1,000 nm, between about 1,000 nm to about 1,500 nm, between about 1,500 nm to about 5,000 nm, between about 5,000 nm to about 10,000 nm, between about 10,000 nm to about 15,000 nm, between about 15,000 nm to about 20,000 nm, between about 20,000 nm to about 25,000 nm, between about 25,000 nm to about 30,000 nm, between about 30,000 nm to about 35,000 nm, between about 35,000 nm to about 40,000 nm, between about 40,000 nm to about 45,000 nm, or between about 45,000 nm to about 50,000 nm. Each possibility is a separate embodiment. Preferably, the diameter of ion exchange nanoparticles may be between about 10 nm to about 200 nm.

According to some embodiments, the polymer matrix may be polyethersulfone (PES), Polyvinylidene Fluoride (PVDF), Polyacrylonitrile (PAN), Polysulfone (PS), sulfonated polysulfone (sPS), acetate, triacetate, and any combination thereof. Each possibility is a separate embodiment. According to some embodiments, the microfilter may include composite particles of a polymer matrix.

As used herein, according to some embodiments, the term “composite particle” may relate to particles composed of one or more materials in any type of arrangement.

According to some embodiments, the active layer of the microfilter may include voids for selective ion adsorption. According to some embodiments, the voids in the active layer may be generated during preparation of the active layer, e.g., during phase inversion, etc. Optionally, the nanoparticles may be located in and/or attached to the walls of the micro and/or macro voids of the polymer matrix.

According to some embodiments, the voids may be micro voids and/or macro voids. Optionally, the voids may be interconnected. According to some embodiments, the micro voids may have a diameter of between about 1 nm to about 5 nm, between about 5 nm to about 100 nm, between about 100 nm to about 500 nm, between about 500 nm to about 1,000 nm, or between about 1,000 nm to about 5,000 nm. Each possibility is a separate embodiment. Optionally, the macro voids may have a diameter of between about 5,000 nm to about 10,000 nm, between about 10,000 nm to about 20,000 nm, between about 20,000 nm to about 30,000 nm, between about 30,000 nm to about 40,000 nm, between about 40,000 nm to about 50,000 nm, between about 50,000 nm to about 60,000 nm, between about 60,000 nm to about 70,000 nm, between about 70,000 nm to about 80,000 nm, between about 80,000 nm to about 90,000 nm, or between about 90,000 nm to about 100,000 nm. Each possibility is a separate embodiment. Preferably, the voids may have a diameter of between about 100 nm to about 500 nm.

According to some embodiments, the porous support may be a sheet, layer or membrane of a porous material. According to some embodiments, the porous support may be a non-woven fabric. Optionally, the porous support may be any organic and/or inorganic support. Optionally, the non-woven fabric may be spun-bonded non-woven fabric, spunlace non-woven fabric, heat bounded non-woven fabric, melt-blown non-woven fabric, wet non-woven fabric, stitch-bonded non-woven fabric, hydrophilic nonwoven fabric, and any combination thereof. Each possibility is a separate embodiment. Non-limiting examples of non-woven fabrics are wool felt, cotton, jute, kenaf, flax polyethylene (PE), nylon polypropylene (PP), polyester (PET), nylon (PA), viscose fiber, acrylic fiber, polyethene fiber (HDPE), chlorine fiber (PVC), and any combination thereof. Each possibility is a separate embodiment.

According to some embodiments, the porous support may have a thickness of between about 10 μm to about 100 μm, between about 100 μm to about 300 μm, or between about 300 μm to about 500 μm. Each possibility is a separate embodiment.

According to some embodiments, the porous support may include pores with a diameter in the range between about 0.1 μm to about 0.5 μm, between about 0.5 to about 5 μm, between about 5 μm to about 10 μm, between about 10 μm to about 25 μm, between about 25 μm to about 50 μm, between about 50 μm to about 100 μm, or between about 100 μm to about 250 μm. Each possibility is a separate embodiment. Preferably, the porous support may include pores with a diameter in the range between about 0.5 μm to about 50 μm.

According to some embodiments, the active layer may have a thickness of between about 10 μm to about 100 μm, between about 100 μm to about 300 μm, between about 300 μm to about 500 μm, between about 500 μm to about 750 μm, or between about 750 μm to about 1,000 μm. Each possibility is a separate embodiment.

According to some embodiments, the ratio of the thickness of the porous support layer to the thickness of the active layer may range between about 1:1 to about 1:5.

According to some embodiments, the active layer may be cast onto a porous support using an automatic film applicator, roll-to-roll production, etc. Optionally, the porous support layer and/or the resulting microfilter may be flexible, foldable, rollable and/or cut to the required size. In addition, the microfilter may be placed in modules, such as a cartridge filter, spiral wound, etc.

As used herein, according to some embodiments, the term “doping” may relate to the intentional introduction of impurities into a material for the purpose of modulating its chemical, electrical, optical and/or structural properties. As used herein, according to some embodiments, the terms “dopant” and “doping agent” may relate to a trace of impurity that is introduced into a chemical material to alter its original properties. As used herein, according to some embodiments, a “doping solution” may relate to a solution containing a doping agent for use in doping a material.

According to some embodiments, the active layer may be doped. According to some embodiments, doping may reduce and/or prevent the leaching of the ion exchange material from the polymer matrix during storage and/or use.

According to some embodiments, the doping agent may be one or more of ferric ions, manganese ions, aluminum ions, copper ions, zinc ions, nickel ions, cobalt ions, and any combination thereof. Optionally, the doping agent may be one or more soluble inorganic compounds, e.g., ferric chloride, ferric nitrate, ferric sulfate, sodium aluminate, potassium aluminum sulfate, and any combination thereof. Optionally, the doping agent may be one or more acids and/or bases. Non-limiting examples of suitable acids for use as doping agents are hydrochloric acid, sulfuric acid, phosphoric acid, nitric acid, acetic acid, boric acid, hydrofluoric acid, oxalic acid, citric acid, carbonic acid, and any combination thereof. Each possibility is a separate embodiment. Non-limiting examples of suitable bases for use as doping agents are lithium hydroxide, sodium hydroxide, barium hydroxide, strontium hydroxide, potassium hydroxide, calcium hydroxide, dimethylketone, methylamine, pyridine, and any combination thereof. Each possibility is a separate embodiment. Preferably, the doping agent may be a ferric ion.

As used herein, according to some embodiments, the term “leaching” may relate to a process of a solute or particle becoming detached or extracted from its carrier substance by way of a solvent.

According to some embodiments, the doping solution may include of a doping agent in an amount of between about 0.0001 wt % to about 0.001 wt %, between about 0.001 wt % to about 0.005 wt %, between about 0.005 wt % to about 0.01 wt %, between 0.01 wt % to about 0.1 wt %, between 0.1 wt % to about 1wt %, or between about 1 wt % to about 10 wt % of the total dope solution. Each possibility is a separate embodiment.

Advantageously, the microfilter may have better kinetics compared to other ion exchange materials, e.g., containing zeolites. According to some embodiments, the nanoparticle form of the ion exchange material may facilitate fast and/or efficient adsorption of ions, resulting in improved performance and reduced contact time required for effective ion removal. Advantageously, the microfilter may be an ideal choice for applications where rapid and/or efficient ion removal is crucial, such as in time-sensitive industrial processes, aquaculture systems with high ammonium loads, toxic spills (e.g., nuclear accidents, industrial accidents, waste overflow, etc.), etc.

According to some embodiments, the microfilter's embedded ion exchange nanoparticles may be easily regenerated, facilitating prolonged usage without the need for frequent replacements. According to some embodiments, regeneration may be performed using highly concentrated salt solutions, e.g., NaCl, KCl, MgCl₂, Na₂SO₄, CaCl₂, etc. and acids, such as, H₂SO₄, HCl, and/or any combination thereof.

As used herein, according to some embodiments, the term “concentrated solution” may have a molarity of between about 2 M to about 4 M, between about 4 M to about 6 M, or about 6 M to about 8 M. Each possibility is a separate embodiment.

According to some embodiments, the ammonium may be removed from the salt solution using various methods, such as indirect electrochemical oxidation to N2 or biological nitrification-denitrification. Optionally, using alkaline stripping of ammonia followed by its adsorption into acid (optionally, using membrane contactors) may enable the recovery of nitrogen fertilizer. Advantageously, regenerating the microfilter may reduce operational costs and/or may minimize waste generation, making the microfilter a sustainable and environmentally friendly option for ammonium removal. Optionally, recovering ammonium as a resource may further add to the circularity and/or sustainability of the methods described herein.

According to some embodiments, a microporous filter (microfilter) may be prepared with a very high metal-hexacyanoferrate nanoparticle load (e.g., up to 65% wt/wt) by immobilizing the metal-hexacyanoferrate nanoparticles within the polymeric matrix for rapid and selective removal of ammonium ions from high ionic strength solutions. According to some embodiments, removed ammonium ions may be recovered into a concentrated salt solution. Additionally, and/or alternatively, these microfilters may be used to remove cesium ions and/or other monovalent or divalent ions from contaminated waters.

Additionally, unlike pure Prussian-blue analogue powders, which often require separation and recovery after use, the embedding an ion exchange material in the polymer matrix of the microfilter advantageously eliminates the need for separation, simplifying the overall process and reducing operational complexities.

According to some embodiments, the Prussian blue analogue may be a metal hexacyanoferrate. According to some embodiments, the metal hexacyanoferrate may be zinc hexacyanoferrate (Zn-HCF), copper hexacyanoferrate (Cu-HCF), cobalt hexacyanoferrate (Co-HCF), nickel hexacyanoferrate (Ni-HCF), indium hexacyanoferrate (In-HCF), platinum hexacyanoferrate (Pt-HCF), potassium hexacyanoferrate (K-HCF), Aluminum hexacyanoferrate (Al-HCF), and any combination thereof. Each possibility is a separate embodiment.

According to some embodiments, the metal hexacyanoferrate may be soluble in polar aprotic solvents include dimethyl sulfoxide, dimethylformamide, dioxane, hexamethylphosphorotriamide, acetone, tetrahydrofuran, chloroform, ethyl acetate, N-methyl-2-pyrrolidone, and any combination thereof. Each possibility is a separate embodiment.

According to some embodiments, the microfilter including a polymer matrix (e.g., polyethersulfone) containing ion exchange (e.g., metal-hexacyanoferrate) nanoparticles may operate effectively in the presence of mixtures of ions and/or high salt solutions. Advantageously, the microfilter may have improved kinetics. The microfilter's simplified recovery process without the need for powder separation, may make it a superior choice for efficient and sustainable monovalent or divalent cation removal in various applications, including domestic and industrial wastewater treatment, aquaculture water management, and cultured meat production. Additionally, and/or alternatively, the microfilter may be used to treat water contaminated with radioactive monovalent cations, e.g., cesium, etc.

According to some embodiments, the microfilter may be prepared and/or stored prior to use.

According to some embodiments, the microfilter may be used in the manufacture of various types of filters, e.g., cartridge filter, hollow fiber filter, spiral wound filter, tubular membrane, etc.

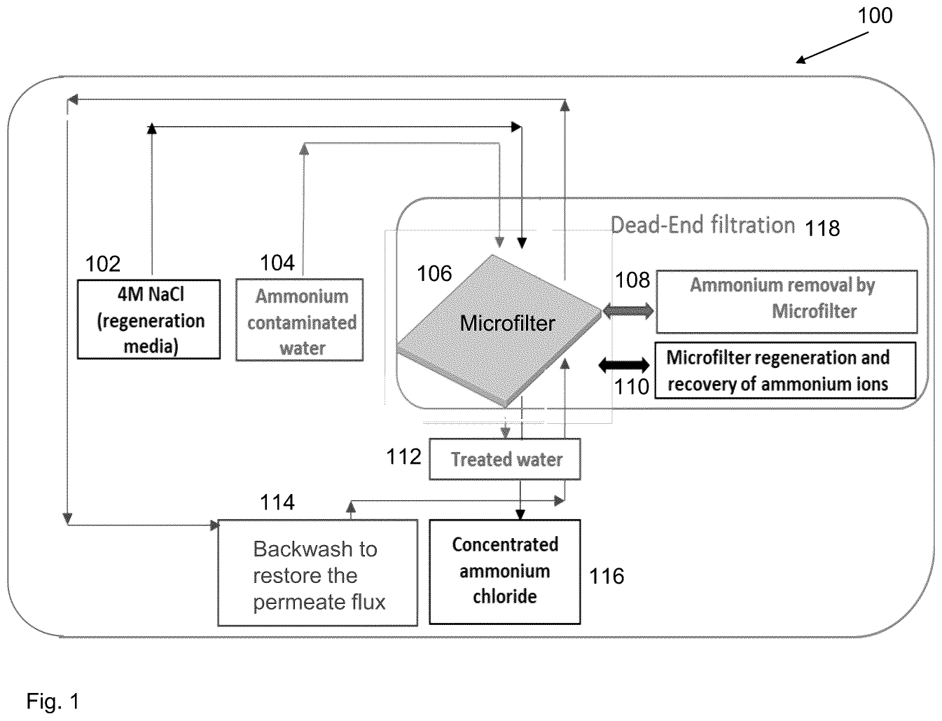

Reference is now made to FIG. 1, which is a process diagram for selectively removing and/or recovering ammonium ions from contaminated water by a cation removal and recovery microporous filter, in accordance with some embodiments. According to some embodiments, in process 100, includes two steps: removal of ammonium from contaminated streams; and ammonium recovery as concentrated ammonium chloride solution. In the first step, a microfilter 106 is exposed to ammonium contaminated water 104. The ammonium ions are removed by the microfilter 108 through dead-end filtration 118 to produce treated water 112. In the second step, microfilter 106 is then regenerated and ammonium ions recovered 110 by exposure of the microfilter 106 to a regeneration medium (e.g., 4M NaCl) 102 to produce concentrated ammonium chloride 116. The microfilter 106 is backwashed to restore the permeate flux 114.

As used herein, according to some embodiments, the term “backwashing” may relate to the common practice in standard filtration, microfiltration, and ultrafiltration, where a pressurized fluid is delivered from the permeate side to the feed side, removing materials that accumulated on the membrane during filtration.

As used herein, according to some embodiments, the term “dead-end filtration” relates to a filtration method whereby the fluids flow is vertical to the filter surface, and the retained particles rapidly solidify on the surface of the filter to form a filter cake, for high product recovery.

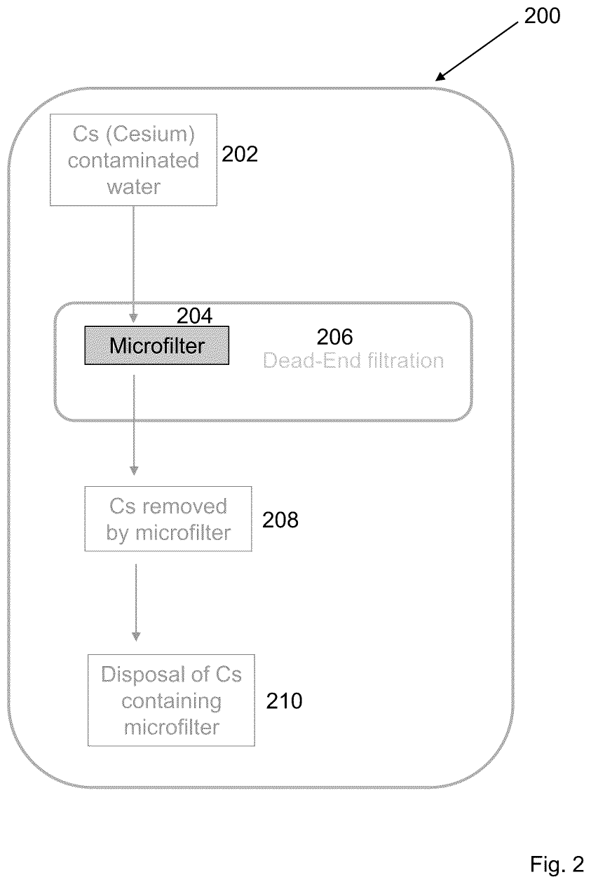

Reference is now made to FIG. 2, which is a process diagram for selectively removing cesium ions from contaminated water by a cation removal and recovery microporous filter, in accordance with some embodiments. According to some embodiments, in process 200, a microfilter 204 is exposed to cesium contaminated water 202. The cesium contaminated water undergoes dead-end filtration 206 using the microfilter to remove the cesium 208 and to provide treated water. The cesium containing microfilter can be disposed of afterwards 210.

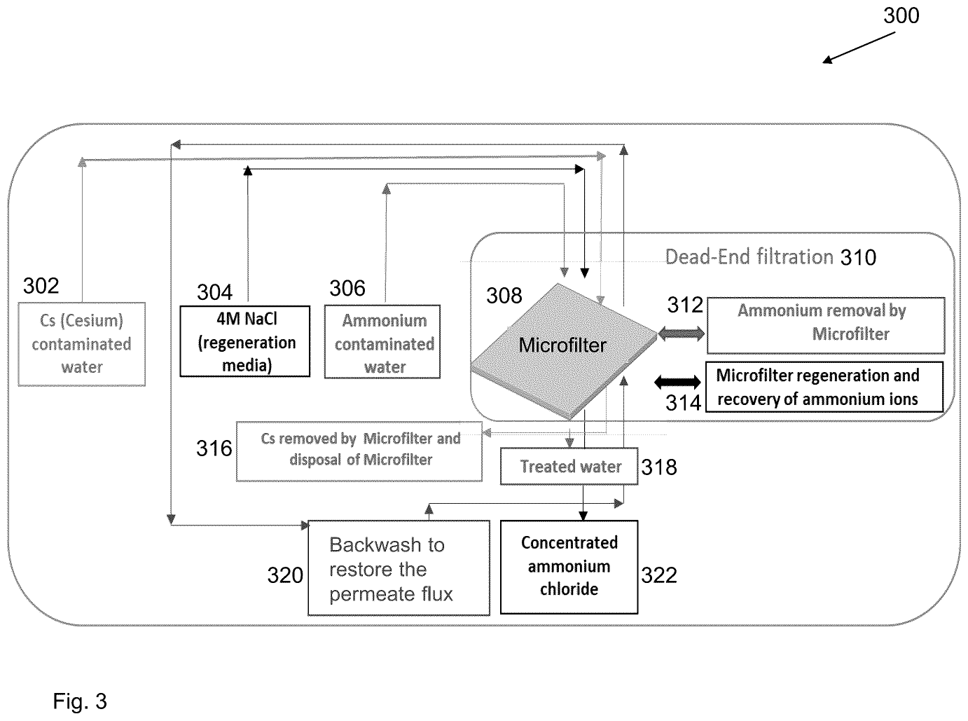

Reference is now made to FIG. 3, which is a process diagram for selectively removing and/or recovering ammonium and cesium ions from contaminated water by a cation removal and recovery microporous filter, in accordance with some embodiments. According to some embodiments, in process 300, includes two steps: removal of ammonium from contaminated streams; and ammonium recovery as concentrated ammonium chloride solution. In the first step, a microfilter 308 is exposed to ammonium contaminated water 306. The ammonium ions are removed by the microfilter 312 through dead-end filtration 310 to produce treated water 318. In the second step, microfilter 308 is then regenerated and ammonium ions recovered 314 by exposure of the microfilter 308 to a regeneration medium (e.g., 4M NaCl) 304 to produce concentrated ammonium chloride 322. The microfilter 308 is backwashed to restore the permeate flux 320.

Additionally, simultaneously and/or subsequently, in process 300, a microfilter 308 is exposed to cesium contaminated water 302. The cesium contaminated water 302 undergoes dead-end filtration 311 using the microfilter 308 to remove the cesium from the water and to dispose of the microfilter afterwards 316.

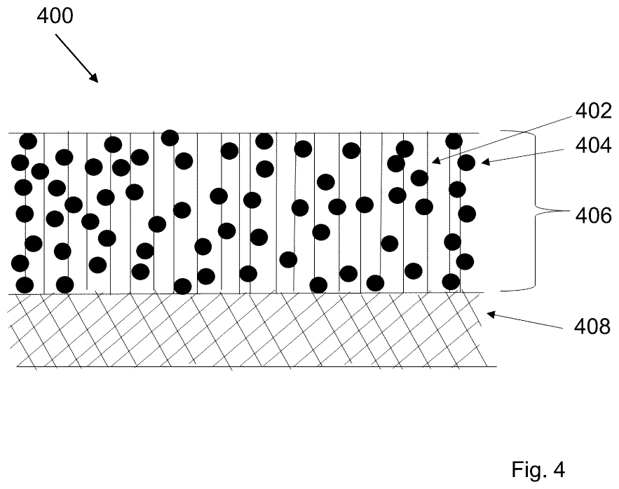

Reference is now made to FIG. 4, which is a cross-sectional schematic diagram of a microporous filter, in accordance with some embodiments. According to some embodiments, microfilter 400 includes an active layer 406 comprising a polymer matrix 402 (e.g., polyethersulfone matrix) containing ion exchange nanoparticles 404 (e.g., Prussian blue analogue) on a porous support 408 (e.g., non-woven polypropylene). For example, the active layer may have a thickness of about 300 μm, and the porous support may have a thickness of about 130 μm. Optionally, the polymer matrix may further comprise a plurality of voids.

### EXAMPLES

### 1. Microporous Filter Preparation

Metal hexacyanoferrate (MHCF) (such as Zinc hexacyanoferrate, Cobalt hexacyanoferrate, Copper hexacyanoferrate) inorganic ion exchange materials were prepared using the procedures reported in the literature (Jiang et al., RSC Adv 8, 34573-34581, 2018; Parajuli et al., Ind Eng Chem Res 55, 6708-6715, 2016; Takahashi et al., Chemical Engineering Research and Design 109, 513-518, 2016). To optimize the MHCF loading (e.g., Zn-HCF, Cu-HCF, Co-HCF, etc.), flat-sheet MHCF microporous filters with different MHCF loading (38.5 wt %; 50 wt %, 62.5 wt %) were prepared. These filters were named Microfilter38.5, microfilter50, and microfilter62.5.

### 1.1 Preparation of Zn-HCF Microporous Filter With Various Zn-HCF Loading

A portion of Zn-HCF adsorbent (about 25 wt % of total loading) was added to N-methyl-2-pyrrolidone (NMP), and the suspension was stirred at 300 rpm for 10 min, followed by sonication for 15 min at room temperature. This procedure was repeated until all the adsorbent material was added. A fixed quantity of polyethersulfone (PES) (about 25 wt % of the total mass of polymer) was then added to the solution, and the solution was stirred for 30 min at room temperature. This procedure was also repeated until all the polymer was added to produce the casting solution. The casting solution was stirred overnight at 300 rpm and then allowed to stand for a few hours for degassing to eliminate any bubbles. The composition of the casting solution is shown in Table 1.

TABLE 1
Composition of casting solution (Microfilter38.5)

| Zn-HCF (%) | PES (%) | NMP (%) |
|---|---|---|
| 9.2 | 14.7 | 76.10 |

The term “casting” as used herein, according to some embodiments, may relate to a manufacturing process in which a liquid material is usually poured into a mould, which contains a hollow cavity of the desired shape, and then allowed to solidify.

The term “phase inversion” as used herein, according to some embodiments, may relate to a process of controlled polymer transformation from a liquid phase to solid phase.

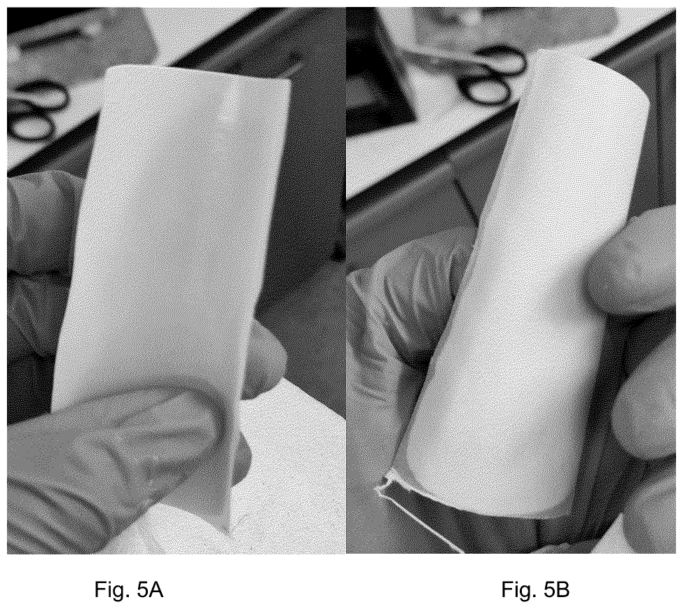

A flat sheet filter with an active layer thickness of about 400 μm was cast on a non-woven polypropylene fabric using an automatic film applicator. During casting, the casting blade speed was maintained at 60 cm/min. After casting, this film was transferred to a deionized water bath (temp: 19±1° C.) to carry out a phase inversion process to prepare a microfilter. The microfilter was stored in deionized water. This filter was named Microfilter 38.5 (FIGS. 5A and 5B).

Leaching of Zn-HCF particles was observed during membrane storage. The membrane was subjected to slow agitation to separate the particles coming out of the membrane matrix, and storage water was replaced several times.

Preventing the leaching of Zn-HCF nanoparticles is crucial for the long-term commercial use of the microfilter. 0.005 wt % FeCl₃·6H₂O (wt % of total dope solution) was added to the casting solution (with about 15.60 wt % PES) (Table 2) before microfilter casting and stirring for a few hours effectively prevented the leaching of Zn-HCF nanoparticles.

Microfilters with higher Zn-HCF nanoparticles loading (50 wt % Zn-HCF nanoparticles of total membrane weight) and active layer thickness around 270-300 μm were prepared. This microfilter was named Microfilter50.

Mirofilter62.5 (62.5 wt % Zn-HCF nanoparticles of total membrane weight) was also prepared using the same procedure. Zn-HCF leaching from this membrane was observed, which indicated that Microfilter50 can be considered as the microfilter with the optimum relative amounts of Zn-HCF and polymer necessary to restrict Zn-HCF particle leaching. The dope solution composition of Microfilter50 is shown in the Table. 2.

TABLE 2
Composition of casting solution (Microfilter50)

| Zn-HCF (%) | PES (%) | NMP (%) |
|---|---|---|
| 15.60 | 15.60 | 66.8 |

### 1.1.1 Surface Morphologies and Water Flux of Zn-HCF38.5 and Zn-HCF50

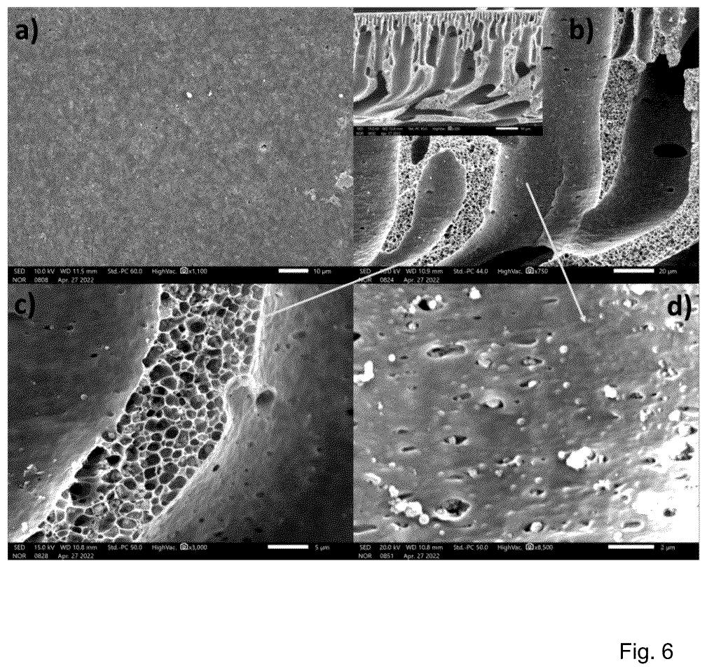

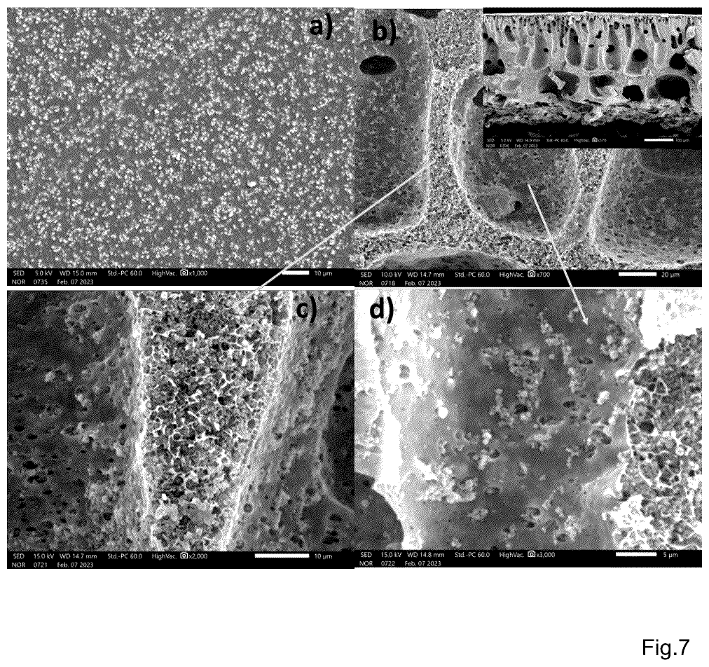

SEM images of both Zn-HCF38.5 and Zn-HCF50 membranes confirm that membrane surface void size lies in the range of microporous membranes. The surface voids size in the range of 0.1 μm or higher were established through the top surface SEM images of both membranes (FIG. 6A and FIG. 7A). The loading of Zn-HCF particles can be seen visible in cross-sectional images (FIGS. 6B, 6C, 6D and FIGS. 7B, 7C, 7D). High loading of clusters of Zn-HCF nanoparticles attached to the polyethersulfone matrix can be seen inside micro and macro voids (FIGS. 6C and 6D). Deionized water fluxes of microfilter38.5 and microfilter50 were around about 500±50 LMH/bar and about 900±250 LMH/bar, respectively. These findings indicate that the higher loading of Zn-HCF particles results in a more porous membrane.

### 1.2 Preparation of Cu-HCF50 and Co-HCF50 Microporous Filters

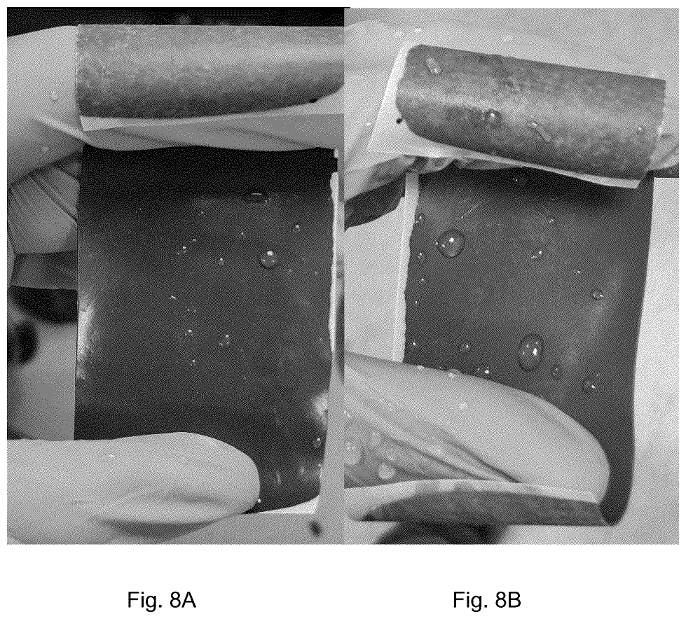

Cu-HCF50 and Co-HCF50 microporous filters (FIGS. 8A and 8B) were also prepared by using the same method and composition (MHCF:PES=50:50) as described in Section 1.1.

### 2. Experimental Conditions and Filtration Setup

Due to the lower cost and low toxicity of Zn ions compared to Co and Cu, Microfilter50 prepared using Zn-HCF, was used to remove ammonium ions from different types of water matrixes. Further, in addition to the Zn-HCF microfilter, Cu-HCF50 microporous filter was also tested for Cs removal from spiked sea water.

A dead-end filtration setup with an effective membrane surface area of 21.85 cm² was used to test these microfilters for ammonium removal and recovery experiments. The estimated weight of the effective membrane surface area was about 0.4 g. The peristaltic pump speed, pump flow rate, and permeate flux were 0.5 rpm, about 1.6 mL/min, and about 42±3 L/m²·h, respectively, while the pressure gauge reading was around zero bar during all the experiments.

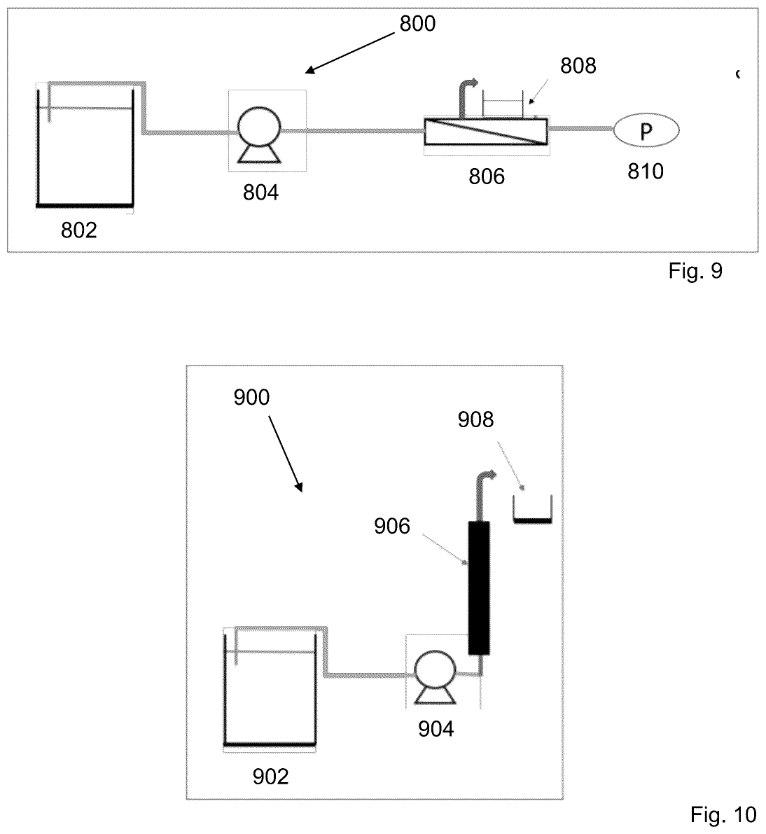

Reference is made to FIG. 9, which is a schematic diagram of an exemplary dead-end filtration setup in accordance with some embodiments. According to some embodiments, the dead-end filtration setup 800 includes a feed tank 802, e.g., containing contaminated water, a pump 804 (e.g., peristaltic pump) which pumps the water from the feed tank 802 into a filtration tank 806, where a flat sheet membrane cell, such as the microfilter filters the water, providing treated water to the permeate collection tank 808. Optionally, a pressure gauge 810 may be connected to the dead-end filtration system (e.g., filtration tank) to monitor the pressure of the system.

Further, the ammonium removal capacity of the metal hexacyanoferrate microfilter was also compared with commercially available zeolite. Zeolite was treated with 1 M NaCl to obtain the zeolite-Na, which is a more efficient ammonium ion exchange materials than zeolite alone. All zeolite-Na column experiments were performed at 10 min HRT. A schematic diagram of the zeolite-Na column experimental setup is shown in FIG. 10.

Reference is made to FIG. 10, which is a schematic diagram of an exemplary zeolite-Na column experimental setup. The zeolite-Na column experimental setup 900 includes a feed tank 902, e.g., containing contaminated water, a pump 904 (e.g., a peristaltic pump) which pumps the water from the feed tank 902 into a zeolite-Na filled column 906, where the water is filtered, providing treated water to the collection tank 908.

### 3. Ammonium Removal and Recovery Experiments

### 3.1 Comparison of Microfilter50 with Microfilter38.5

To compare the performance of Microfilter38.5 and Microfilter50, dead-end filtration experiments were carried out on ammonium spiked (NH₄⁺: about 70 mg/L) deionized water having an ionic strength of 0.015 M NaCl (Conductivity: about 2.4 mS and pH: 6.3). Spent membranes were regenerated using 4 M NaCl and used for another cycle. Experimental conditions such as pump rpm (0.5 rpm) and permeate flux (about 45 LMH) were maintained unchanged during the ammonium removal and membrane regeneration experiments.

### 3.1.1 Removal and Recovery of Ammonium Ions From Synthetic and Real Water Matrixes

A microporous filter (Microfilter50) with a thickness of about 490±15 μm (active layer thickness of about 330 to 350 μm) was selected for detailed ammonium removal and recovery experiments. The same microfilter50 after regeneration was used repeatedly for different ionic strengths (0.015, 0.025, 0.05, 0.1, 0.015, and 0.5 M NaCl) of ammonium spiked deionized water, natural water (Brackish water and seawater) matrices and ammonium contaminated water collected from a recirculating aquaculture system (e.g., fishpond). A second microfilter50 was also prepared and used to reproduce the results. Occasionally, Microfilter50 was back washed at 3 bar operating pressure using deionized water to restore permeate flux.

During the filtration experiments, samples were collected from the feed tank, the permeate channel, and the permeate collection tank at various intervals, and ammonium concentration was measured using the Nessler method and salicylate methods.

The ammonium removal (%) performance, removal capacity (mg/g), and removal capacity per m2 of the membrane were estimated using the following equations.
a. Ammonium removal (%)

$$Ammonium removal ( \% ) = ( 1 - ( \frac{Ct}{{C}_{0}} ) ) * 100$$

$$wherein$$

$${C}_{0} = Feed ammonium concentration ( mg / L ) ;$$

Cₜ=Ammonium concentration in the sample collected from the permeate channel at time t.

The time (t) was when ammonium removal reaches almost zero indicates the saturation of membrane-active sites. The permeate volume collected up to this time was used to estimate the membrane capacity.
b. Ammonium removal capacity (mg/g)

The ammonium removal capacity (mg/g of membrane) of the Microfilter50 was estimated using the following equations:

$$Microfilter capacity ( mg / g ) = \frac{( {C}_{0} - {C}_{f} )}{M / V}$$

$$wherein$$

$${C}_{0} = Feed ammonium concentration ( mg / L ) ;$$

C_{f}=accumulative ammonium concentration reached in permeate collection tank up to the saturation of membrane-active sites (mg/L);
M=the dry weight of membrane (g);
V=Volume of treated water collected in the permeate collection tank (L) up to membrane saturation.

The estimated dry weight of the effective membrane surface (21.85 cm²) was 0.4 g.
c. Ammonium removal capacity (mg/m²)

Ammonium removal capacity per m² of effective membrane area was estimated using the following equation:

$$Q ( mg / {m}^{2} ) = ( ( {C}_{0} - {C}_{f} ) * V ) / A$$

$$wherein$$

$${C}_{0} = initial feed concentration ( mg / L ) ;$$

C_{f}=accumulative ammonium concentration in permeate collection tank up to the saturation of membrane (mg/L);
V=Volume of permeate collected up to the membrane saturation (L);
A=Effective area of membrane (m²)

### 3.1.2 Comparison of Microfilter50 With Commercially Available Zeolite

To check the commercial feasibility of Microfilter50, the ammonium removal performance of this microporous filter was also compared with the commercially available Zeolite ion exchange material. A Thomas model was also used to predict the removal capacity of zeolite (during column experiments) and microporous Filter50 (during the Dead-End filtration experiment). Linear and non-linear forms of the Thomas model are as follows:

$$Linear form :$$

$$ln ( \frac{{C}_{t}}{{C}_{0}} - 1 ) = {k}_{th} \times {Q}_{th} \times \frac{M}{Q} - {k}_{th} \times {C}_{0} \times t$$

$$Non - Linear form :$$

$$\frac{{C}_{t}}{{C}_{0}} = \frac{1}{1 + {e}^{( {k}_{th} \times {Q}_{th} \times \frac{M}{Q} - {k}_{th} \times {C}_{0} \times t )}}$$

$$Y = 1 / ( 1 + exp ( ( a * b * c ) - ( a * d * t ) ) )$$

wherein
   a=Kₜₕ;
   b=Qₜₕ;
   c=M/Q;
   d=C₀
wherein
   Kₜₕ=Thomas Constant;
   Qₜₕ=Ammonium removal capacity;
   M=mass of ion exchange material/membrane;
   Q=Flow rate in L/h;
   C₀=Feed ammonium concentration in mg/L;
   t=time in h.

### 3.2 Cesium Removal Experiments-Seawater

Metal hexacyanoferrate microfilters are used to remove cesium from spiked (about 150 mg/L) seawater. All other experimental conditions are maintained unchanged from the ammonium removal experiments.

### 3.3 Cesium Removal Experiments—Brackish Water

Metal hexacyanoferrate microfilters are used to remove cesium from spiked (about 150 mg/L) brackish water. All other experimental conditions are maintained unchanged from the ammonium removal experiments.

### 4. Effect of Regeneration Media pH on Microfilter Performance

A 4 M NaCl solution can be used to regenerate the microporous filter. Further, the pH of the regeneration media was increased by NaOH (0, 5 mM, 0.5 M), and ammonium removal experiments were performed for spiked brackish water (ammonium: about 30 mg/L).

### 5. Comparison of Microfilter38.5 and Microfilter50

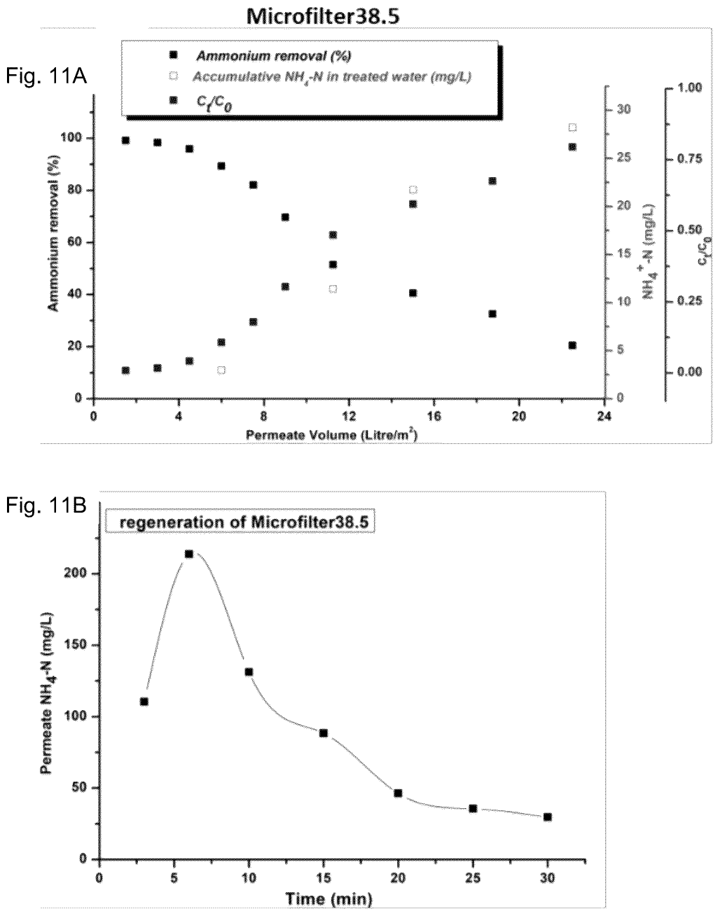

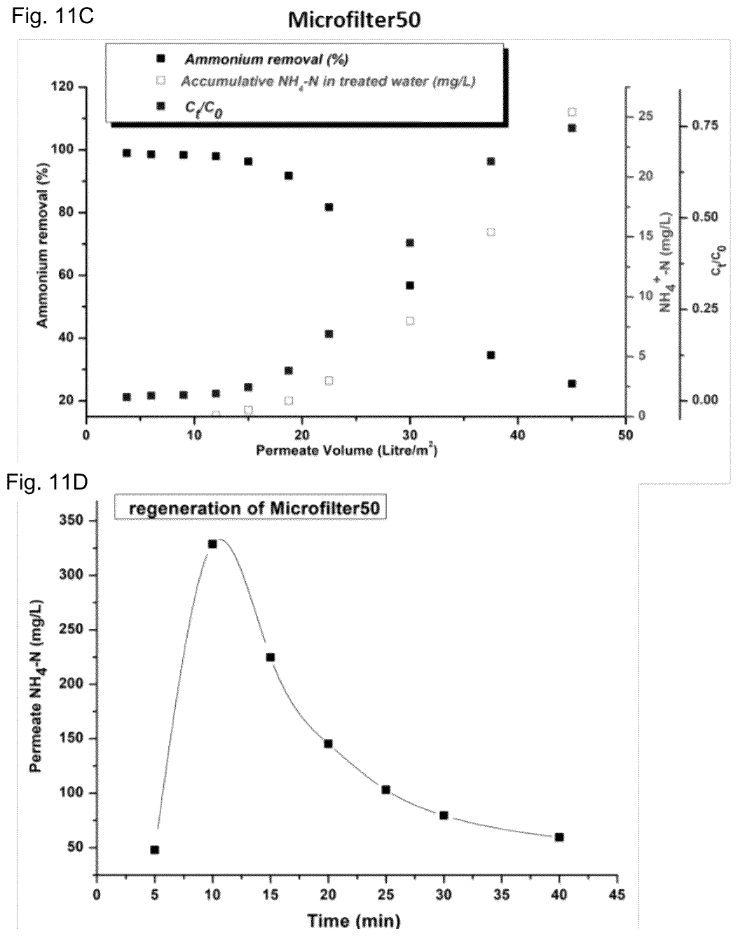

A comparison of ammonium removal performances of Microfilter38.5 and Microfilter50 (FIGS. 11A and 11C) reveals that Microfilter50 outperforms Microfilter38.5 and can be used to produce a higher volume of treated water. Further, the breakthrough point was reached earlier in the case of Microfilter38.5, which can be attributed to low loading during preparation and the leaching of Zn-HCF particles. Microfilters were regenerated using 4 M NaCl, and ammonium can be recovered as ammonium chloride solution by concentrating it into NaCl solution (FIGS. 11B and 11D). Permeate ammonium concentration trend (FIGS. 11B and 11D) reveals that removed ammonium ions can be recovered effectively over a short time. These ammonium removal experiments were carried out with ammonium (about 70 mg/L) spiked 0.1 M NaCl solution. All experimental conditions, such as feed composition, pH (about 6.3), conductivity (2.44 mS), and permeate flux (about 44 LMH) were the same for both experiments.

Due to the leaching of Zn-HCF particles from Microfilter38.5 matrix and its inferior performance to Microfilter50, the latter was selected for detailed ammonium removal and recovery experiments from different ionic strength synthetic and real water matrixes.

### 6. Ammonium Removal From Different Ionic Strength Solutions

Experimental results obtained for different ionic strength solutions reveal the applicability of Microfilter50 for commercial applications. These experiments were performed on Microfilter50 which was regenerated and reused repetitively for different ionic strength solutions. Experimental conditions such as permeate flux (about 44 LMH), feed ammonium concentration (about 70 mg/L), regeneration media composition (4 M NaCl) kept same for all experiments.

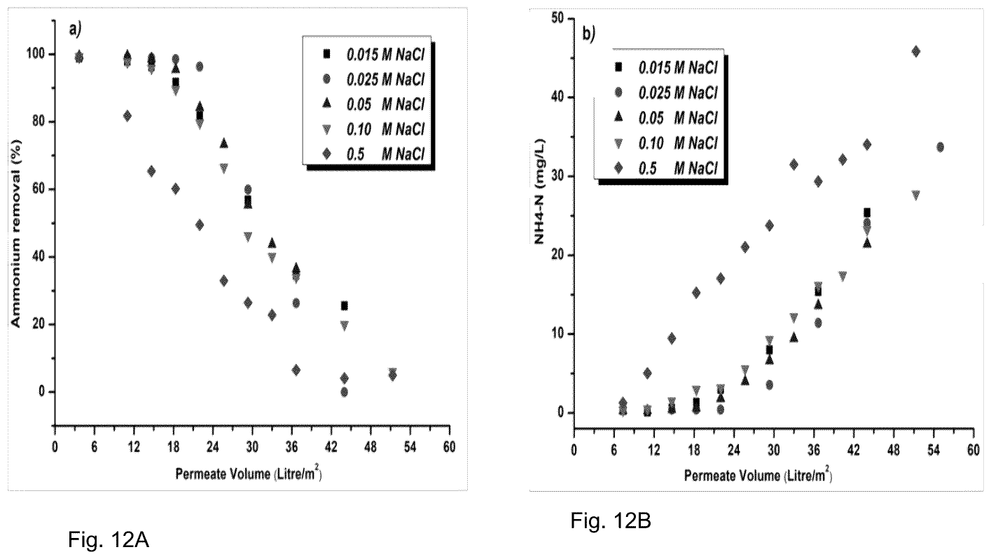

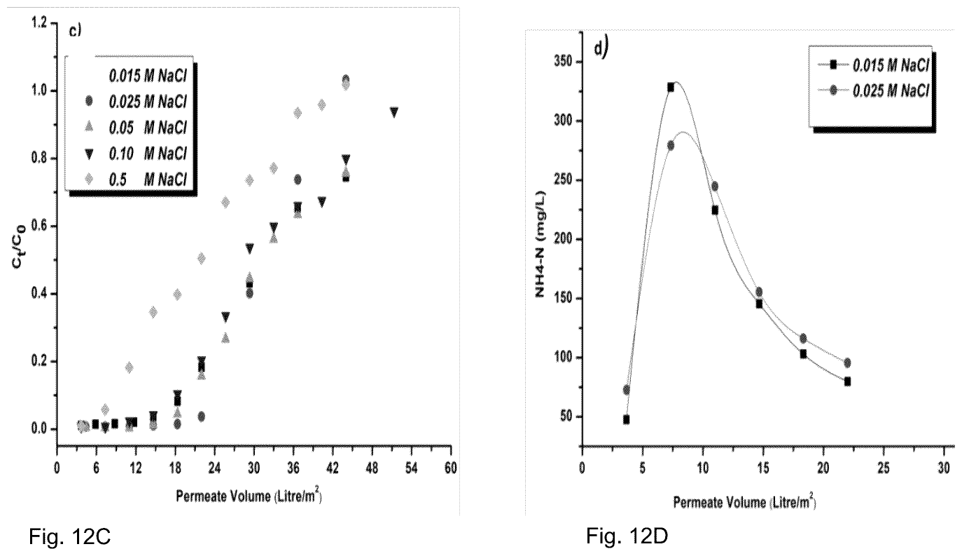

No significant effect of ionic strength on ammonium removal performance was observed (FIGS. 12A and 12B). Although at 0.5 M NaCl ionic strength (about equivalent to seawater), a decrease in ammonium removal performance was observed.

Further, accumulative ammonium concentration in treated water and breakthrough curve (FIG. 12C) reveals that a significant volume of treated water with very low ammonium concentration can be produced. Further, removed ammonium was recovered by concentrating it into regeneration media over a short period (FIG. 12D).

The same microfilter50 was used repeatedly for different NaCl ionic strength solutions after regeneration. Permeate flux was also restored after each experiment and found to be 43±2 LMH. Microporous filter (with 1 m² surface area) can treat a volume of about 55 L before achieving saturation, except for spiked 0.5 M NaCl solution where saturation was reached early—at only about 35 L. A similar ammonium removal capacity of about 2 g NH4-N/m² was achieved for different ionic strength solutions from 0.015 M NaCl to 0.1 M NaCl solutions (Table 3).

TABLE 3
Feed compositions and ammonium removal capacity of Microfilter50 for different
ionic strength solutions (Dry weight of membrane (21.85 cm2): about 0.4 g)

| | | | | | Removal | Removal |
|---|---|---|---|---|---|---|
| | Ionic | | Feed | Removal | Capacity | capacity of |
| | strength | Conductivity | NH₄⁺—N | Capacity | (mg/g of | membrane* |
| Cycle | (M NaCl) | of feed (mS) | (mg/L) | (g/m²) | membrane) | (mg/g) |
| 1 | 0.015 | 2.4 | 69 | 1.99 | 10.9 | — |
| 2 | 0.025 | 3.5 | 68 | 1.86 | 10.2 | — |
| 3 | 0.05 | 6 | 68 | 1.98 | 10.8 | — |
| 4 | 0.1 | 11.10 | 70 | 1.98 | 10.9 | 11.62 |
| 5 | 0.5 | 48.2 | 70 | 1.52 | 8.3 | 7.92 |

*As predicted by Thomas Model

### 7. Ammonium Removal From Real Water Matrizes

### 7.1 Spiked Brackish Water

The same regenerated microfilter50 used for different NaCl solutions was used to remove and recover the ammonium ions from spiked (NH₄—N about 30 mg/L) Brackish water (pH: 7.8, conductivity: 4.0 mS). The ionic composition of feed and treated brackish water is shown in Table 4.

TABLE 4
Ionic composition of feed and treated
ammonium spiked brackish water

| | Na | Cl | Ca | Mg | K | S | Sr |
|---|---|---|---|---|---|---|---|
| | (mg/ | (mg/ | (mg/ | (mg/ | (mg/ | (mg/ | (mg/ |
| Sample | L) | L) | L) | L) | L) | L) | L) |
| Feed | 608.3 | 1144 | 150.6 | 68.4 | 16.5 | 92.4 | 5.16 |
| Treated | 643.5 | 1100 | 142.8 | 67.2 | 6.93 | 90.6 | 4.86 |
| brackish | | | | | | | |
| water | | | | | | | |

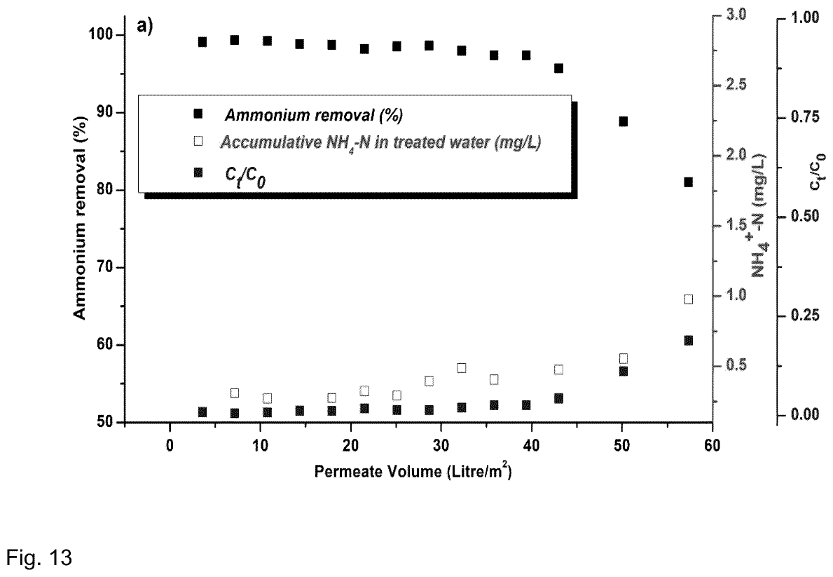

The ammonium removal performance of microfilter50 for brackish water show a breakthrough curve and accumulative ammonium concentration (FIG. 13) indicated that a significant volume (about 50 L per m² of filter surface area) of treated brackish water with an ammonium concentration of about 0.5 mg/L could be produced using this filter. FIG. 13 shows a chart of ammonium removal, breakthrough curve, and accumulative ammonium concentration during spiked Brackish water (NH₄-N: 30 mg/L, pH: 7.8, conductivity: about 4 mS) experiment, where the permeate flux during the experiment was about 43 LMH.

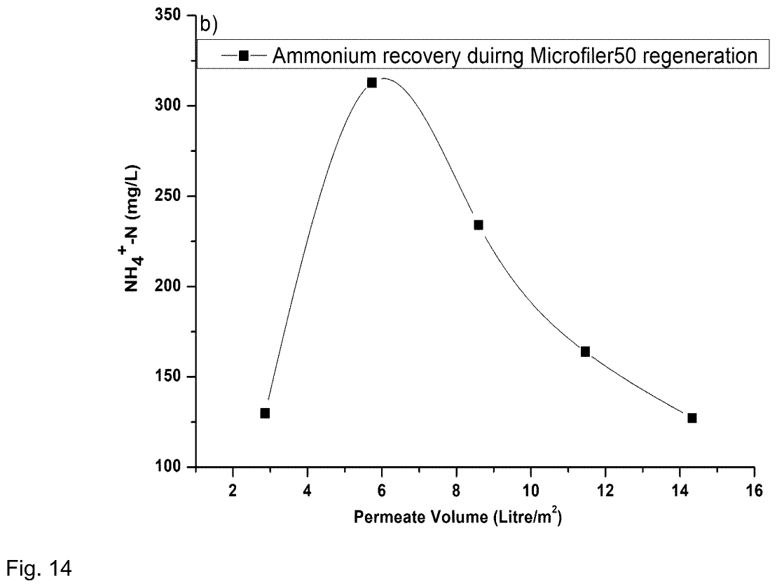

Adsorbed ammonium per m² of microfilter was recovered as concentrated ammonium chloride solution (NH₄—N about 350 mg/L, Volume: 6 L) (FIG. 14). Results also indicate that the microfilter can selectivity removes ammonium in the presence of other cations such as Sodium, calcium, and magnesium. FIG. 14 shows a chart of accumulative permeate ammonium concentration during microfilter recovery, the regeneration media used was 4 M NaCl.

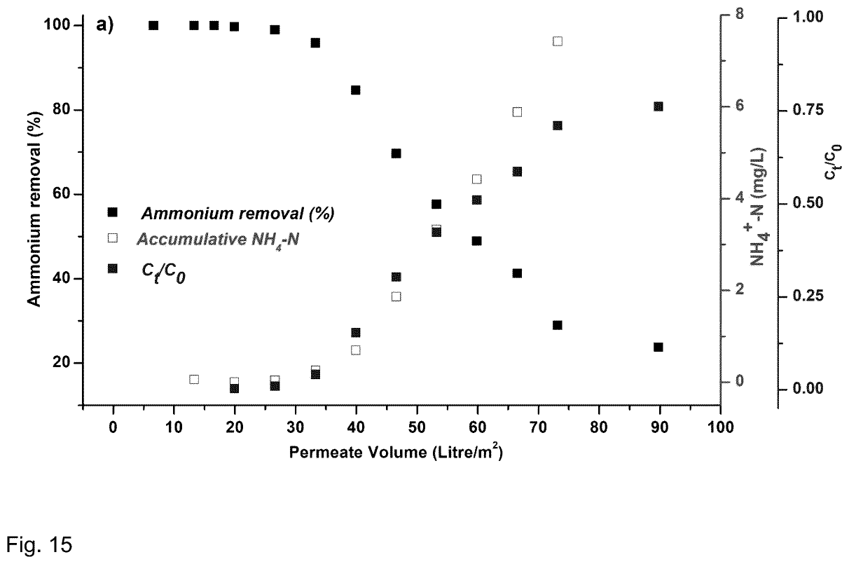

This experiment was repeated with another Microporous filter with the same compositions. Brackish water used in this experiment has higher conductivity (about 4.5 mS) than the previous experiment (about 4.0 mS). Ammonium removal results (FIG. 15) indicate inferior performance for higher ionic strength Brackish water. Still, Microfilter50 had an ammonium removal capacity of about 1.85 g/m². FIG. 15 shows a chart of ammonium removal performance repeat experiment with another microfilter50 (permeate flux: 40 LMH). The ionic composition of feed and treated brackish water is shown in Table 5.

TABLE 5
Brackish water composition during repeat experiment.

| | Na | Cl | Ca | Mg | K | S |
|---|---|---|---|---|---|---|
| Sample | (mg/L) | (mg/L) | (mg/L) | (mg/L) | (mg/L) | (mg/L) |
| Feed | 608.3 | 1144 | 153.6 | 78.84 | 15.72 | 133.2 |
| Treated | 643.5 | 1100 | 145.2 | 74.88 | 9.36 | 128.4 |
| Brackish | | | | | | |
| water | | | | | | |

### 7.2 Spiked Seawater

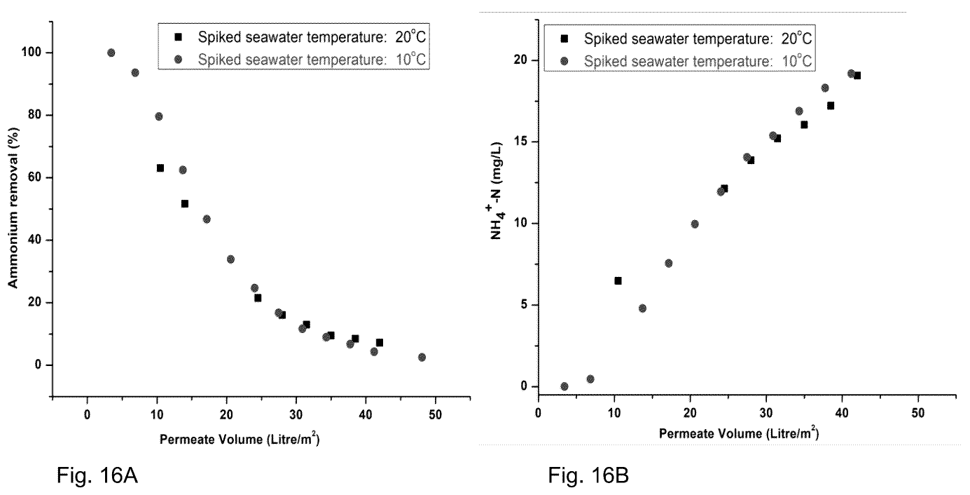

Experimental results obtained for spiked seawater (pH-7.8; conductivity: 60 mS; NH₄—N: 30 mg/L) indicate that microfilter50 can remove ammonium from seawater selectively. Ammonium removal results (42 LMH, 41.2 LMH for 20 and 10° C.) and accumulative ammonium concentration (FIGS. 16A and 16B) reveal that Microfilter50 removes about 10% more ammonium at a lower temperature (10° C.) than higher temperature (20° C.) while considering the time for collection of 14-liter permeate. Though at a later stage, a similar trend was observed at both temperatures. The estimated ammonium removal capacity of microfilter50 for spiked seawater was about 0.48 g/m2 microfilter indicating its applicability for very high ionic strength solutions.

### 7.3 Bio-Flock Recirculatory Fish Aquaculture Pond Water

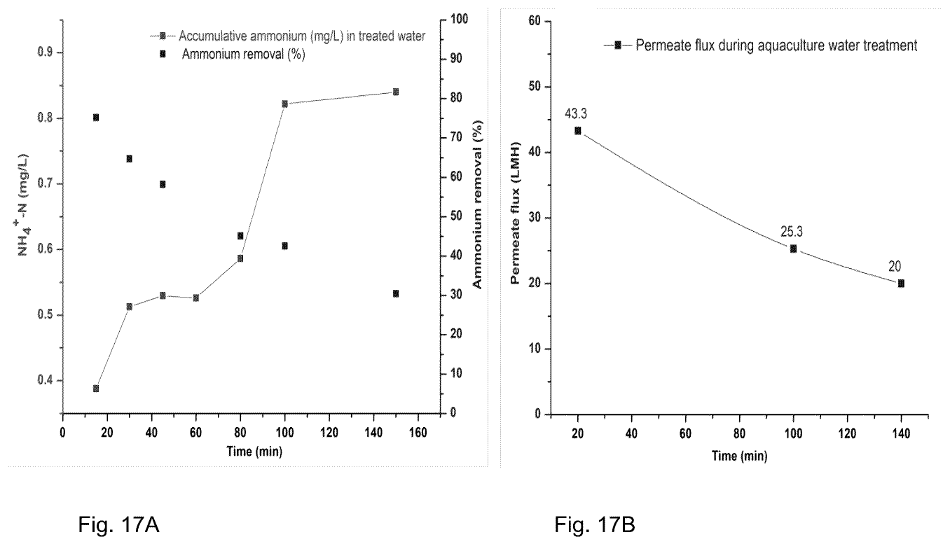

Bio-flock Recirculatory fish aquaculture pond water having very high turbidity and suspended particles was filtered through a 1.5 μm filter to remove bacteria, and other large, suspended particles before its treatment through microfilter50. Afterward, ammonium concentration was measured and found to be about 1.55 mg/L. Experimental results show that treated fishpond water with an accumulative ammonium concentration about 0.5 mg/L can be produced over a period of 1 h (FIG. 17A). The presence of a lag phase in FIG. 17A was attributed to an increase in contact time between ammonium and adsorbent active sites. However, a decrease in permeate flux was observed over time (FIG. 17B), which was attributed to the presence of fine suspended particles with size less than 1.5 μm. If the average flux over 90 min is considered, then about 51.45 L treated fish water with an ammonium concentration about 0.8 mg/L was produced.

After the fish aquaculture pond water experiment, microfilter50 was back washed at 2 bar for 20 min with DI water to recover permeate flux. After backwash, a flux of 41.2 LMH was observed at 0.5 rpm peristaltic pump speed, indicating that very fine suspended particles were responsible for pore blockage which led to a decrease in permeate flux. After regeneration, the same microfilter was used to remove Cs from spiked seawater.

### 8. Comparison of Microfilter50 With Commercially Available Zeolite Ammonium Ion Exchange

The ammonium removal capacity of Microfilter50 was compared with Zeolite-Na (column experiment). The ammonium removal using Zeolite-Na was performed through column experiments. A schematic diagram of a Zeolite-Na column experimental setup was shown in FIG. 10. The Thomas model was used to predict the removal capacity (mg/g) of membrane and Zeolite-Na granules.

### 8.1 Ammonium Spiked Deionized Water With 0.1 M NaCl Ionic Strength

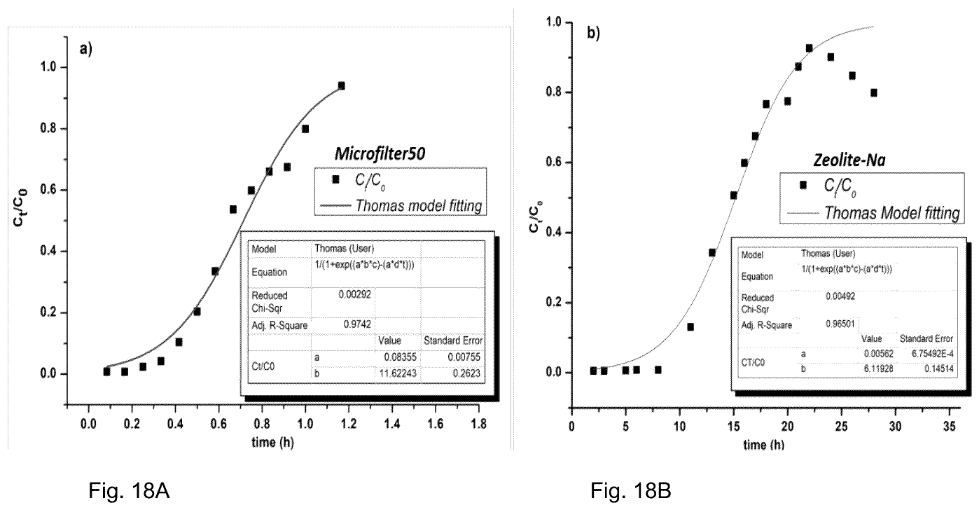

A comparison of the Thomas model fitting for Microfilter50 (FIG. 18A) and Zeolite-Na (FIG. 18B). The Thomas model predicted ammonium removal capacity for Microfilter50 and Zeolite-Na were found to be 11.62 mg/g and 6.11 mg/g, respectively. These results corroborate well with earlier finding about negative effect of high ionic strength solution on Zeolite performance, and also reveal that Microfilter50 performs better the Zeolite-Na in higher ionic strength solutions.

### 8.2 Ammonium Spiked 0.15 M NaCl in the Presence of Other Monovalent and Divalent Ions

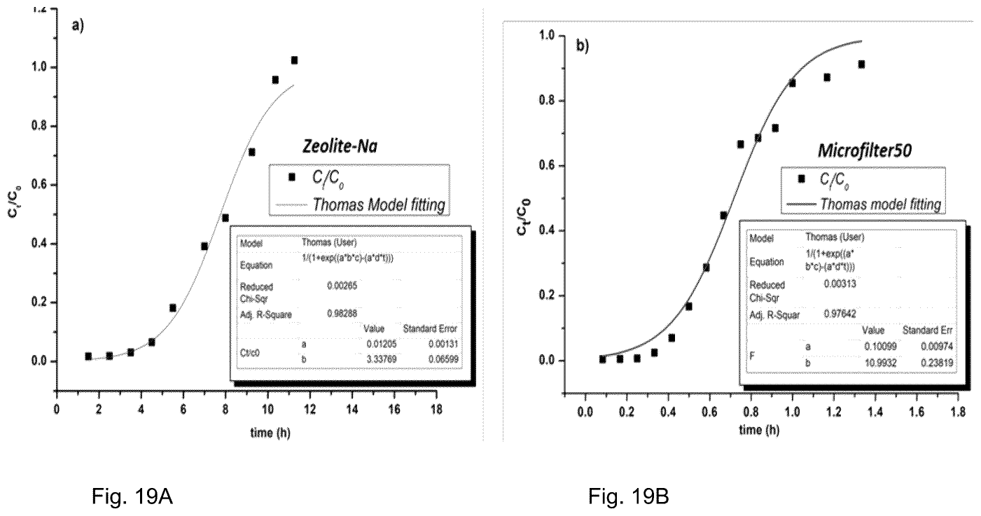

The removal performance of Microfilter50 and Zeolite was also examined for higher ionic strength solution (0.15 M NaCl) in the presence of other competitive ions. Thomas model fitting was used to predict ammonium removal capacity of Microfilter50 (FIG. 19A) and Zeolite-Na (FIG. 19B) for 0.15 M NaCl in presence of other mono and divalent ions. The ionic composition of feed and treated water is shown in Table 6. No significant effect of higher ionic strength and other ions was observed on Microfilter50 while deterioration in performance was observed for Zeolite-Na. Thomas's model predicted ammonium removal capacity for Microfilter50 and Zeolite-Na were 10.99 mg/g and 3.34 mg/g respectively. The high selectivity of Microfilter50 towards ammonium ion indicate its applicability for different applications.

TABLE 6
Composition of feed solutions

| | Ca | Mg | K | Na | Cl | | NH₄⁺—N |
|---|---|---|---|---|---|---|---|
| Experiment | (mg/L) | (mg/L) | (mg/L) | (mg/L) | (mg/L) | pH | (mg/L) |
| Zeolite-Na | 32.65 | 70 | 152 | 4045 | 5800 | ~7.8 | 65.7 |
| Column | | | | | | | |
| Microfilter50 | 32.8 | 7.6 | 150 | 4020 | 5800 | ~7.8 | 66 |

### 9. Effect of Regeneration Media pH on Microfilter Performance

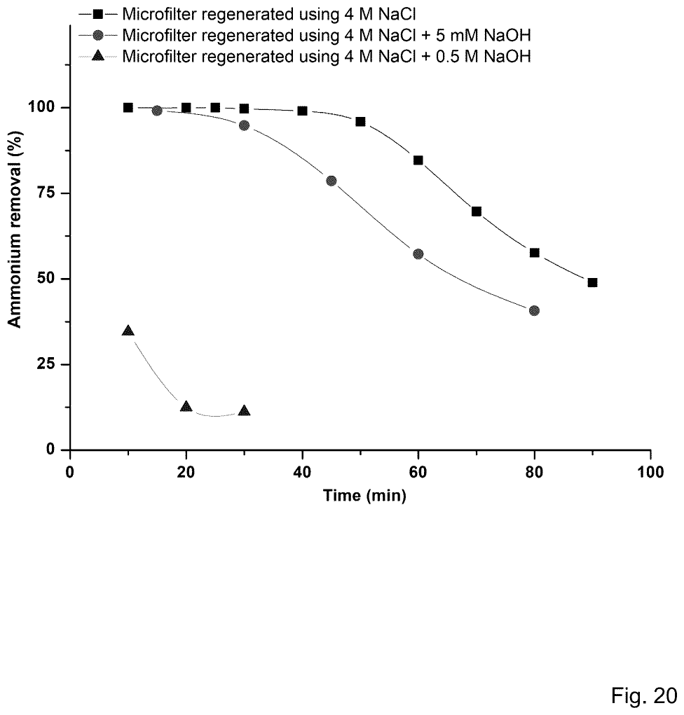

Experimental results shown in FIG. 20 reveal that an increase in pH affects the microfilter performance negatively. Microfilter regenerated with regeneration media with 5 Mm NaOH (about 11 pH) shows slightly inferior performance, but regeneration media with 0.5 M NaOH affects microfilter performance drastically, leading to very low ammonium removal. These results indicated low stability of Zn-HCF nanoparticles in high pH solutions.

Having thus described several embodiments for practicing the inventive method, its advantages and objectives can be easily understood. Variations from the description above may and can be made by one skilled in the art without departing from the scope of the invention.

Accordingly, this invention is not to be limited by the embodiments as described, which are given by way of example only and not by way of limitation.

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, according to some embodiments, the term “prevent” may relate to stop, hinder and/or mitigate.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the term “about” may be used to specify a value of a quantity or parameter (e.g., the length of an element) to within a continuous range of values in the neighbourhood of (and including) a given (stated) value. According to some embodiments, “about” may specify the value of a parameter to be between 80% and 120% of the given value.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purposes and should not be regarded as limiting. Citation or identification of any reference in this application shall not be construed as an admission that such reference is available as prior art to the disclosure. Section headings are used herein to ease understanding of the specification and should not be construed as necessarily limiting.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

The following examples are presented to provide a more complete understanding of the invention. The specific techniques, conditions, materials, proportions and reported data set forth to illustrate the principles of the invention are exemplary and should not be construed as limiting the scope of the invention.

1-51. (canceled)

52. A microporous filter for the selective removal and/or recovery of cations from water, the microporous filter comprising:
an active layer deposited on a porous support, wherein the active layer comprises:
a voids-containing polymer matrix;
ion exchange nanoparticles embedded within the voids-containing polymer matrix; and
a doping agent to reduce or prevent leaching of the nanoparticles from the active layer, thereby facilitating a high load of the ion exchange nanoparticles of at least about 30% wt of the active layer,
such that introduction of water through the microporous filter results in treated water, wherein said treated water is characterized by a reduced amount of cations, as compared to the introduced water.

53. The microporous filter of claim 52, wherein the high load of the ion exchange nanoparticles in the active layer is from about 30 wt % to about 80 wt %.

54. The microporous filter of claim 52, wherein the ion exchange nanoparticles comprise a Prussian-blue analogue.

55. The microporous filter of claim 54, wherein the Prussian-blue analogue is a metal hexacyanoferrate (MHCF) selected from the group consisting of zinc hexacyanoferrate (Zn-HCF), copper hexacyanoferrate (Cu-HCF), cobalt hexacyanoferrate (Co-HCF), indium hexacyanoferrate (In-HCF), platinum hexacyanoferrate (Pt-HCF), potassium hexacyanoferrate (K-HCF), aluminum hexacyanoferrate (Al-HCF), and any combination thereof.

56. The microporous filter of claim 52, wherein the doping agent comprises one or more ions, one or more water-soluble inorganic compounds, one or more acids, one or more bases, or any combination thereof.

57. The microporous filter of claim 56, wherein the one or more ions is selected from the group consisting of ferric ions, manganese ions, aluminum ions, copper ions, zinc ions, nickel ions, cobalt ions, sodium ions, potassium ions, and any combination thereof.

58. The microporous filter of claim 52, wherein the doping agent is selected from the group consisting of ferric chloride, ferric nitrate, ferric sulfate, sodium aluminate, potassium aluminum sulfate, aluminum chloride, aluminum sulfate, hydrochloric acid, sulfuric acid, phosphoric acid, nitric acid, acetic acid, boric acid, hydrofluoric acid, oxalic acid, citric acid, carbonic acid, lithium hydroxide, sodium hydroxide, barium hydroxide, strontium hydroxide, potassium hydroxide, calcium hydroxide, dimethylketone, methylamine, pyridine, and any combination thereof.

59. The microporous filter of claim 52, wherein the voids-containing polymer matrix is selected from the group consisting of polyethersulfone (PES), polyvinylidene fluoride (PVDF), polyacrylonitrile (PAN), polysulfone (PS), sulfonated polysulfone (sPS), cellulose acetate, cellulose triacetate, and any combination thereof.

60. The microporous filter of claim 52, wherein the active layer has a thickness from about 100 μm to about 1,000 μm.

61. The microporous filter of claim 52, wherein the porous support is a non-woven fabric.

62. The microporous filter of claim 61, wherein the non-woven fabric is a non-woven material selected from: wool felt, cotton, jute, kenaf, flax polyethylene, nylon polypropylene, polyester, polyethylene terephthalate (PET), nylon, polyamide, viscose fiber, acrylic fiber, polyethylene fiber, high-density polyethylene (HDPE), chlorine fiber, polyvinyl chloride (PVC), and any combination thereof.

63. The microporous filter of claim 52, wherein the porous support comprises pores with a diameter of between about 0.01 nm to about 1,000,000 nm.

64. The microporous filter of claim 52, wherein the removed and/or recovered cations are monovalent or divalent cations.

65. The microporous filter of claim 64, wherein the monovalent or divalent cations are selected from the group comprising ammonium ions, cesium ions, lead ions, cadmium ions, or any combination thereof.

66. A method for removing cations from water, the method comprising:
contacting a microporous filter with water, wherein the microporous filter comprises an active layer deposited on a porous support, said active layer comprises:
a voids-containing polymer matrix;
ion exchange nanoparticles embedded within the voids-containing polymer matrix; and
a doping agent to reduce or prevent leaching of the nanoparticles from the active layer, thereby facilitating a high load of the ion exchange nanoparticles of at least about 30% wt of the active layer,
such that the contacting of the microporous filter with the water produces treated water, wherein said treated water is characterized by a reduced amount of cations, as compared to the contacted water.

67. The method of claim 66, further comprising regenerating the microporous filter and/or recovering the removed cations.

68. The method of claim 67, wherein the regeneration of the microporous filter and/or the recovery of the cations comprises contacting the microporous filter with a concentrated aqueous solution comprising an acid or salt selected from the group consisting of NaCl, KCl, MgCl₂, Na₂SO₄, CaCl₂, H₂SO₄, HCl, and any combination thereof.

69. A method for the preparation of a microporous filter for the selective removal of cations from water, the method comprising:
combining a polymer with an ion exchange nanoparticles suspension in a polar aprotic solvent to obtain a solution;
doping the obtained solution with a doping agent; and
depositing the solution onto a porous support, to produce an active layer film comprising a void-containing polymer matrix, wherein the void-containing polymer matrix comprises the ion exchange nanoparticles in at least about 30 wt % of the active layer film.

70. The method of claim 69, further comprising phase inversion of the polymer, to produce the voids of the voids-containing polymer matrix.

71. The method of claim 69, wherein the doping of the obtained solution with a doping agent is performed using a doping solution, wherein the doping solution comprises the doping agent in an amount of between about 0.0001 wt % to about 1 wt % of the total doping solution.
